(19) United States
(12) Patent Application Publication
(10) Pub. No.: US 2023/0308158 A1
(43) Pub. Date: Sep. 28, 2023

(54) INFLUENCING THE BEHAVIOUR OF BEAM CORRESPONDENCE

(71) Applicant: Fraunhofer-Gesellschaft zur Förderung der angewandten Forschung e.V., München (DE)

(72) Inventors: Thomas HAUSTEIN, Berlin (DE); Paul Simon Holt LEATHER, Berlin (DE); Mathis SCHMIEDER, Berlin (DE)

(21) Appl. No.: 18/301,035

(22) Filed: Apr. 14, 2023

Related U.S. Application Data
(63) Continuation of application No. PCT/EP2021/078500, filed on Oct. 14, 2021.

(30) Foreign Application Priority Data
Oct. 16, 2020 (EP) 20202359.4

(51) Int. Cl. H04B 7/06

(52) U.S. Cl. CPC H04B 7/06952

(57) ABSTRACT

A network node configured for wirelessly transceiving signals for operating in a wireless communication network is to form a response beam pattern responsive to a recognized stimulus of a stimulating node based on a criterion. The network node is to receive a signal indicated a request to influence the criterion and is to influence the criterion based on the request.

### CROSS-REFERENCE TO RELATED APPLICATIONS

This application is a continuation of copending International Application No. PCT/EP2021/078500, filed Oct. 14, 2021, which is incorporated herein by reference in its entirety, and additionally claims priority from European Application No. 20202359.4, filed Oct. 16, 2020, which is also incorporated herein by reference in its entirety.

The present application concerns the field of wireless communication systems or networks, more specifically, to the behaviour of network nodes when deciding about beamforming, e.g., during beam correspondence or beam management procedures. Embodiments of the present invention concern devices and methods related to influence such a behaviour.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, ...RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/ LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length. For example, in 5G a subframe has a duration of 1 ms, as in LTE. The subframe includes one or more slots, dependent on the subcarrier spacing. For example, at a subcarrier spacing of 15 kHz the subframe includes one slot, at a subcarrier spacing of 30 kHz the subframe includes two slots, at a subcarrier spacing of 60 kHz the subframe includes four slots, etc. Each slot may, in turn, include 12 or 14 OFDM symbols dependent on the cyclic prefix, CP, length.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including space borne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station, e.g., GSM, UMTS, LTE base stations, that may not support certain service, like NR V2X services.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(a) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1. The UEs directly communicating with each other include a first vehicle 152 and a second vehicle 154 both in the coverage area 150 of the base station gNB. Both vehicles 152, 154 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a Mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 156, 158 and 160 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(b) which is the out-of-coverage scenario does not necessarily mean that the respective Mode 2 UEs in NR or mode 4 UEs in LTE are outside of the coverage 150 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 150 shown in FIG. 2(a), in addition to the NR Mode 1 or LTE Mode 3 UEs 152, 154 also NR Mode 2 or LTE mode 4 UEs 156, 158, 160 are present. In addition, FIG. 2(b), schematically illustrates an out of coverage UE using a relay to communicate with the network. For example, the UE 160 may communicate over the sidelink with UE1 which, in turn, may be connected to the gNB via the Uu interface. Thus, UE1 may relay information between the gNB and the UE 160.

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is noted that the information in the above section is only for enhancing the understanding of the background of the invention and, therefore, it may contain information that does not form conventional technology that is already known to a person of ordinary skill in the art.

### SUMMARY

An embodiment may have a network node configured for wirelessly transceiving signals for operating in a wireless communications network; wherein the network node is to form a response beam pattern responsive to a recognized stimulus of a stimulating node based on a criterion; wherein the network node is to receive a signal including a request to influence the criterion; wherein the network node is to influence the criterion based on the request.

Another embodiment may have a network node configured for wirelessly transceiving signals for operating in a wireless communications network; wherein the network node is to transmit a signal indicating a request, to a responding network node, to influence a criterion according to which the responding network node selects a response beam pattern as a response to a stimulus.

According to another embodiment, a method to operate a network node to wirelessly transceive signals for operating in a wireless communications network, the network node to form a response beam pattern responsive to a recognized stimulus of a stimulating node based on a criterion, may have the steps of: receiving a signal indicating a request to influence the criterion; and changing the criterion based on the request;

According to another embodiment, a method to operate a network node to wirelessly transceiving signals for operating in a wireless communications network may have the step of: transmitting a signal indicating a request, to a responding network node, to influence a criterion according to which the responding network node selects a response beam pattern as a response to a stimulus.

### BRIEF DESCRIPTION OF THE DRAWINGS

Embodiments of the present invention will be detailed subsequently referring to the appended drawings, in which:

FIG. 1 is a schematic representation of an example of a terrestrial wireless network, wherein FIG. 1(a) illustrates a core network and one or more radio access networks, and FIG. 1(b) is a schematic representation of an example of a radio access network RAN;

FIG. 2 schematic represents in-coverage and out-of-coverage scenarios, wherein FIG. 2(a) is a schematic representation of an in-coverage scenario in which two UEs directly communicating with each other are both connected to a base station, and FIG. 2(b) is a schematic representation of an out-of-coverage scenario in which the UEs directly communicating with each other,

FIG. 3 is a schematic diagram of at least a part of a wireless communication network in which a network node such as a base station or gNB forms a set of wide beams, according to an embodiment;

FIG. 4 is a schematic block diagram of the wireless communication network of FIG. 3 in which the UE decides to use a narrow beam responsive to having recognized beams from the base station, according to an embodiment;

FIG. 5 is a schematic block diagram of the wireless communication network of FIG. 3 in which the gNB transmits a narrow beam and the UE may decide to use narrow beam as a response, according to an embodiment;

FIG. 6 is a schematic block diagram of the wireless communication network of FIG. 3 in a scenario in which the gNB uses narrow beams whilst UE decides to respond with wide beam, according to an embodiment;

FIG. 7 is a schematic flow chart of signals and messages exchanged during downlink, DL, beam management, BM, procedures for initial access, IA, according to an embodiment;

FIG. 8 is a schematic flow chart of signals and messages exchanged during uplink, UL, beam management, BM, procedures for initial access, IA, according to an embodiment;

FIG. 9 shows a schematic block diagram of a network node according to an embodiment;

FIG. 10 is a schematic block diagram of a network device according to an embodiment; which may operate as a transmitter;

FIG. 11 is a schematic block diagram of a network node according to an embodiment, configured for wirelessly transceiving signals;

FIG. 12 shows network node of FIG. 11 in a modified form, where a criterion is implemented, at least in parts, by a set of partial criterions, according to an embodiment;

FIG. 13 is a schematic block diagram of a network node according to an embodiment where the criterion may be represented as a NxM matrix;

FIG. 14 is a schematic block diagram of a network node according to an embodiment in which a stimulus is related or identified to a class of beams received;

FIG. 15 is a schematic block diagram of a wireless communication network according to an embodiment and being an alternative representation of the concept illustrated in connection with FIG. 14;

FIGS. 16a-b are schematic block diagrams of a wireless communication network according to an embodiment;

FIG. 17 shows a schematic block diagram of a network node according to an embodiment being referred to as UE-type #2 and/or UE-type #4; and

FIG. 18 is a schematic block diagram of a network node according to an embodiment, configured to log requests.

### DETAILED DESCRIPTION OF THE INVENTION

Embodiments of the present invention are now described in more detail with reference to the accompanying drawings, in which the same or similar elements have the same reference signs assigned.

Embodiments of the present invention are based on the finding that the known behaviour of a UE so as to decide a response to a stimulus it recognizes may lead, at least in some cases, to unwanted behaviour and/or may be subject to optimization. Embodiments are based on the finding that a network node implements a certain criterion for deciding or selecting a response beam pattern responsive to a recognized stimulus. Some embodiments relate to modifying this criterion in a desired way so as to achieve at least implicitly the desired behaviour whilst allowing to keeping the precise mechanisms in implemented in the network node hidden or secret, which might be in the interest of the manufacturer of the network node.

Embodiments are also based on the idea so as to use the knowledge about the criterion to be implemented in the network node so as to generate a respective stimulus that leads to the desired behaviour at the responding node, i.e., the responding network node is provoked to show the desired behaviour. Although this may incorporate some sort of falsification of the stimulus, i.e., a different stimulus is used that would be used in a regular procedure, the response obtained may be optimized with regard to one or more parameters when compared to a regular response.

Embodiments relate to react on a determined stimulus with a responding, stimulated node. Embodiments are described herein in connection with a stimulus beam pattern being formed by a stimulating node and being recognised at or with a stimulated node that responds. Although relating to a beam pattern as a stimulus, embodiments are not limited hereto but relate, without limitation to other types of information that may be recognized at the stimulated node. In particular, embodiments relate to information carried over the air, i.e., transmitted wirelessly from one node to another. The information may be part of a signal and/or may be carried otherwise.

For example, when relating to a signal, the stimulus may relate to a stimulus beam pattern. The beam pattern may be recognised at the stimulated node directly, e.g., by having knowledge about the pattern itself, e.g., based on measurements of the pattern, but may also evaluate signals such as reference signals transmitted with the beam pattern. Such A reference signal, RS, may provide for a marking of a specific channel or beam transmitted from the stimulating source and may thus also identify the stimulating beam pattern although the stimulus itself may be or may contain the reference signal.

However, alternatively or in addition other information may be at least a part of the stimulus. For example, a frequency of a signal transmitted by the stimulating node may indicate the stimulus and may, thus, form a direct or indirect stimulus. Alternatively or in addition, a polarization of the transmitted signal and/or of a received signal may indicate or form at least a part of the stimulus, such that different frequencies and/or different polarization lead to different reactions or responses.

Alternatively or in addition, a position of a specific information, within a reference frame, time slot, burst, OFDM symbol etc. may form the stimulus at least in parts. Further additional or alternative examples for a stimulus are, for example, a direction of transmission/reception, a cell ID, etc.

Embodiments relate to a stimulating network node and a stimulated, responding network node. The stimulus for stimulating the responding network node my come from, e.g., Another network node e.g. a gNB or UE but also from a test and measurement equipment, T&M. Thus, the stimulating node is not necessarily a network node of a network of which the responding node is a part but may also be a device used for testing the responding node which is not necessarily part of a network, at least at this stage of testing but possibly during later operation.

The over the air signal containing the stimulus may, according to some embodiments, be subject of beamforming. The stimulus may be beamformed at one or more of the receiver and the transmitter. For example, at the receiver node or at least one reception chain thereof, the beamforming may be implemented before the signal is evaluated, e.g., in view of its content, using, e.g., coherent and/or non-coherent combining and/or using different antennas or antenna arrays. Alternatively, or in addition, the stimulus may be beamformed at the transmitter side, e.g., by using a wide beam, a narrow beam, a (quasi) omnidirectional beam or the like. Such a decision of the transmitter may be recognized at the receiver and evaluated.

One illustrative example, may, thus be, to adapt spatial reception filters in a case where signals are received from two or more nodes at the same time. By thereby forming or adapting spatial reception filters, a stimulus may also be the reception filter being used to receive and/or decode the desired signal with sufficient quality, i.e., at least to receive one signal better than other signals, such that the reception filter may indicate or form at least a part of the stimulus.

That is, one example, relates to a stimulus being at least in parts being formed by a reference signal, RS, which may be applied/embedded in potential beams coming from the base station. Alternatively or in addition, a same or different stimulus may refer to a spatial receive filter applied by the stimulated node, e.g., a UE, before going into a decision how to react, which is referred herein as a sensitivity matrix.

For example, the stimulus may relate to an input synchronization signal block, SSB, a Channels State Information Reference Signal, CSI-RS, such that the stimulus may be described as the signal SSB/CSI-RS but also with the beam pattern to which the signals are related, e.g., as they represent wide beam, a narrow beam respectively. This does not exclude an understanding that the stimulus or stimulus beam pattern may be identified by a spatial filter/receiver beam pattern applied onto the stimulus input signal. The stimulus beam pattern thus relates also to parameters related with the beam pattern, i.e., to beam pattern related parameters such that the stimulus may also be referred to as a beam pattern related parameter. That is, according to embodiments, the network node may recognize the stimulus as an information embedded into a signal and/or a spatial filter used for reception and/or transmission of the signal. It is, thus possible, to derive information from a spatial filter, i.e., a beam former when operating in reception and/or transmission.

Embodiments described herein relate to forming a response beam pattern response to having determined a stimulus. Although some embodiments are described in a way that the stimulus is a beam pattern or at least relates to a beam pattern and/or is transmitted by way of a transmission, TX, beam pattern being formed by a first network node and being determined or recognized or received by a second, responding network node so as to form a transmission beam pattern towards the first network node and/or to form a receptions beam pattern towards the first network node. The embodiments described herein relate, without limitation, to scenarios in which the first network node forms a response, RX, beam pattern.

Although embodiments described herein may relate to a UE being a responding network node that responds to a beam pattern being formed by a base station forming the stimulating network node, embodiments are not limited to a configuration of a base station communicating with one or more user equipment. As described, embodiments also relate to test scenarios in which a device is tested in a T&M environment, e.g., a measurement chamber. The ideas underline the present invention as well as the embodiments described herein are not limited to such a configuration, but may be implemented by any network node that communicates with another network node being implemented for beam forming.

Further embodiments of the present invention relate to logging or storing received requests, e.g., a request sent to the receiving, logging network node or to a different network node and/or for processing, evaluating and using such logged requests.

In connection with embodiments described herein, the following definitions may apply

The “DEVICE TO BE INFLUENCED” is defined as a network-connected entity that has the means to allow its behaviour to be influenced by a second network-connected entity. Whereas the first and second network-connected entities might ordinarily form a communication link, such a constraint is not applicable to the definition of the “DEVICE TO BE INFLUENCED” used herein.

The “DEVICE TO BE INFLUENCED” is capable of responding to influencing actions, instructions, requests, commands and configurations (subsequentially referred to as influencing data).

The “DEVICE TO BE INFLUENCED” does not necessarily allow itself to be influenced by all or any device that attempts to influence its behaviour. A level of selection, priority, authority or hierarchy is thus observed by the “DEVICE TO BE INFLUENCED” wherein examples of requests from public safety, law enforcement, lawful interception or regulatory investigation may not be denied. Alternatively, incentive driven requests may be optionally addressed.

“DEVICE TO BE INFLUENCED” responsiveness should be accompanied by a traceable certification of validity. In this context, validity is used to mean the quality of the influencing data.

The “DEVICE TO BE INFLUENCED” records or logs influencing data in a continuous, timed (low-speed, high-speed, dynamic-speed), sequenced, ordered, requested, windowed, instructed, event-based/trigger-based/threshold-based or programmed/scripted manner. In the case of event triggering, the “DEVICE TO BE INFLUENCED” can perform actions in either a semi-autonomous or completely autonomous manner. The influencing data can be recorded as-is or “raw”, uncompressed, compressed, averaged (running average/windowing), statistically processed or reduced (1^{st} order, 2^{nd} order statistics) or is otherwise filtered. Furthermore, the influencing data can be recorded individually or as part of a defined group. That is, although embodiments described herein relate to a request that is received by a network node, embodiments also relate to influencing actions, instructions, requests, commands and configurations.

A “DEVICE TO BE INFLUENCED” can record a selection of measured (QoS) parameters together with a header, identifier, marker, stamp containing one or more of: absolute time; relative time; time relative to a slot, a frame or the start of service (uptime); the speed over ground; location (GPS/GNSS coordinates); altitude; cell ID; cell sector; beam directions; beam reference signals, identifiers and/or markers; SSID; ISP; PLM; MNO; RAT connection type (5G, 4G, 3G, 2G, Wi-Fi, Bluetooth, LORAN); service type (VoIP, Video On Demand, augmented reality, virtual reality).

The “DEVICE TO BE INFLUENCED” influencing data can be open, locked or otherwise protected for example by using block chain principles to limit unauthorised access, tampering or other forms of falsification.

The “DEVICE TO BE INFLUENCED” influencing data depth (sampling interval, granularity) may be set according to parameter or a KPI requirement.

Moreover, when a “DEVICE TO BE INFLUENCED” works in an autonomous or semi-autonomous manner, it can record or log influencing data destined for another “DEVICE TO BE INFLUENCED”, thus acting as a proxy-logger.

A “DEVICE TO BE INFLUENCED” can identify an event and send a COMMAND/NOTIFICATION to a second “DEVICE TO BE INFLUENCED” such that the second device is requested to log and/or report influencing data. This COMMAND/NOTIFICATION may contain explicit instructions for example the time (moment) of the logging. Furthermore, an activation period, validity of requested logging and/or reporting could be part of further content of the COMMAND/NOTIFICATION. The signalling procedure of the COMMAND/NOTIFICATION should include a confirmation of execution etc and fallback options, if COMMAND/NOTIFICATION was not received and/or certain actions requested could not be successfully executed.

“DEVICE TO BE INFLUENCED” reports can be sent regularly, continuously, on demand, repeatedly, according to a schedule, at certain times, proactively, autonomously and/or automatically. “DEVICE TO BE INFLUENCED” reporting can be orchestrated by higher network entities, events or situations, or be triggered by parameter threshold or certain events (e.g. the rate of repetition of requests).

When a link failure is detected by the “DEVICE TO BE INFLUENCED” at both ends of a link, one or both ends should provide a “before and while” link failure report to the other end automatically or on request after link/connection re-establishment.

Where and if available, the “DEVICE TO BE INFLUENCED” reports via an auxiliary measurement/reporting channel, a dedicated physical/logical reporting channel or a dedicated inter-MNO/inter-PLMN physical/logical reporting channel. In accordance with the channel being used, the “DEVICE TO BE INFLUENCED” uses the appropriate signalling structure and format including all needed encryption, compression, encoding and security measures. The transmission of the “DEVICE TO BE INFLUENCED” report can be timed, sequenced, ordered, requested, instructed, event-based/trigger-based/threshold-based (e.g. upon returning home) or programmed. The “DEVICE TO

BE INFLUENCED” sends its report to at least one of a network entity, a communication partner, a next member of a defined group, a basestation, a mobile network operator (MNO), a server running over-the-top (see below), a higher authority (for example, a regulator), an original equipment manufacturer (OEM) or a service provider.

A “DEVICE TO BE INFLUENCED” can report all of the recorded data sets containing selected parameters or KPI dimensions, information or conclusions during a given period (time window) or a subset of the data set thereof.

“DEVICE TO BE INFLUENCED” reporting can be into one direction (e.g. UE to network or network to UE) or in both directions. Furthermore, a third entity or further devices or entities in the network can be the source and/or the destination of such reports. If the report destination is not defined, the report can be sent in any direction away from the reporting “DEVICE TO BE INFLUENCED”. The number of “away-from-me” hops can be counted and limited according to configuration including the avoidance of loops or “home returns”.

The “DEVICE TO BE INFLUENCED” does not necessarily report to all the devices that request a report from it. A level of selection, priority, authority or hierarchy is thus observed by the “DEVICE TO BE INFLUENCED” wherein examples of requests from public safety, law enforcement, lawful interception or regulatory investigation may not be denied. Alternatively, incentive driven requests may be optionally addressed.

“DEVICE TO BE INFLUENCED” reporting should be accompanied by a traceable certification of validity. In this context, validity is used to mean the quality of the measured data for example with traceability to a measurement laboratory, test house, certification authority and so on.

Multiple “DEVICE TO BE INFLUENCED” operations may need orchestration wherein a central entity distributes or allocates measurement commands and tasks to a plurality of “DEVICES TO BE INFLUENCED”. The central entity can be thought of as a conductor of an orchestra and is thus a node or a device in the active link-this could also include the core network “behind” the radio link. The node or device does not necessarily have to be a network entity nor an entity of a similar radio access technology (RAT). Inter-RAT “DEVICES TO BE INFLUENCED” are thus considered including examples of Wi-Fi, Bluetooth, DECT and 3GPP LTE/NR and systems beyond the current 5G technology. Further examples include test and measurement (T&M) equipment that connect to one or more “DEVICES TO BE INFLUENCED” without necessarily being connected to the network.

Multiple DEVICES TO BE INFLUENCED may operate without orchestration through virtue of their autonomous or semi-autonomous functions (educated behaviour) and, by using suitable markers, enable post-mortem analysis of influencing data. In this context, educated behaviour is not limited to include: swarm intelligence algorithms; embedded incentive functions based on game theory; and post-training pattern observation classification (e.g. using a “DNA print” obtained from a manufacturer).

Embodiments relate to an enhanced method to facilitate beam management and alignment in bi-directional communication between two device/node using beamforming on one or both sides of the communication link, wherein the transmit beamformer at one or two devices is selected/computed by exploiting the mechanism of beam correspondence. Beam correspondence is a feature of a communication device to respond with a transmit beam of a particular pattern and direction based on an observation of a wireless stimulus received from another device wherein the beam corresponding capable device will determine the corresponding transmit beam (semi-) autonomously. The proposed method disclosed in the invention report will allow ways of assistance, orchestration, ways of influencing the beam correspondence feature when implemented in a device and/or network.

The core of this invention disclosure describes a framework to coordinate:
UE behaviour with respect to its response to a stimulus to be influenced
The stimuli a receiver should observe e.g. SSB or CSI-RS; as an example, a UE could respond to SSB or CSI-RS (INPUT). If the UE is responding on SSB, then any change of CSI-RS beam will not be treated as an input signal and therefore any optimization of the CSI-RS beam on the BS side has no impact on the transmit beam selection on the UE side...
Options how several stimuli are weighted and/or prioritized as inputs
Specifics of targeted output signals to be requested e.g. respond with wide or narrow beam
E.g. UE should respond with a wide beam or a narrow beam (OUTPUT)
UE should respond in a prioritized fashion given options (how to calculate OUTPUT)
UE should respond with a superposition of output options or algorithmic paths (OUTPUT)

Wireless communication systems tend to use wireless resources more efficiently and increasingly exploit channel knowledge for a better adaptation of the transmit strategy/filter to the channel and the receiver’s capabilities.

An example is beamforming allowing to focus transmitted energy into spatial directions which combined with the wireless propagation channel and the receiver antenna directionality allows a reliable communication at reduced, advantageously minimum energy/power.

Wireless communication devices may make decisions about their transmit beamformers exploiting help from the corresponding communication partner via beam selection feedback, similar to downlink feedback on CSI-RS defined in 3GPP TS 38.331, TS38.306, TS38.214. In the case of downlink, the base station provides a set of beams and the user will provide feedback in two forms:
Type I: the receiver reports a beam by signalling a matrix index (PMI) to the transmitter/base station or
Type II: receiver reports a weighted combination of one or more beams by providing amplitude and phase multipliers together with the PMI, see WO 2018/223351 A.

Type II feedback allows the transmitter to form one or more new beams, based on the set of beams that were originally provided, in a user specific manner.

As an alternative to the aforementioned feedback mechanisms, independent decisions on beam selection can be made which exploit the reciprocity of the wireless channel. This mechanism is often referred to as beam correspondence and can be signalled as a UE capability since 3GPP release 15.

The receive beam is usually selected based on observation/detection of known pilots / reference symbols (RS) which allow to identify the characteristics of the wireless propagation channel during a channel estimation phase. In LTE and NR there exist a variety of RS embedded in the frame structure of the transmission block, where the RS can be precoded in various ways or non-precoded at all.

If one or both ends of a bi-directional communication link use such mechanisms like beam correspondence, then it is beneficial for the communication partner to know on the one hand which RS are used as input signals and on the other hand which kind of output/transmit beam selection mechanism is to be used e.g. by responding with a narrow or wide beam. In particular such knowledge is of importance for convergence when applied for iterative beam alignment.

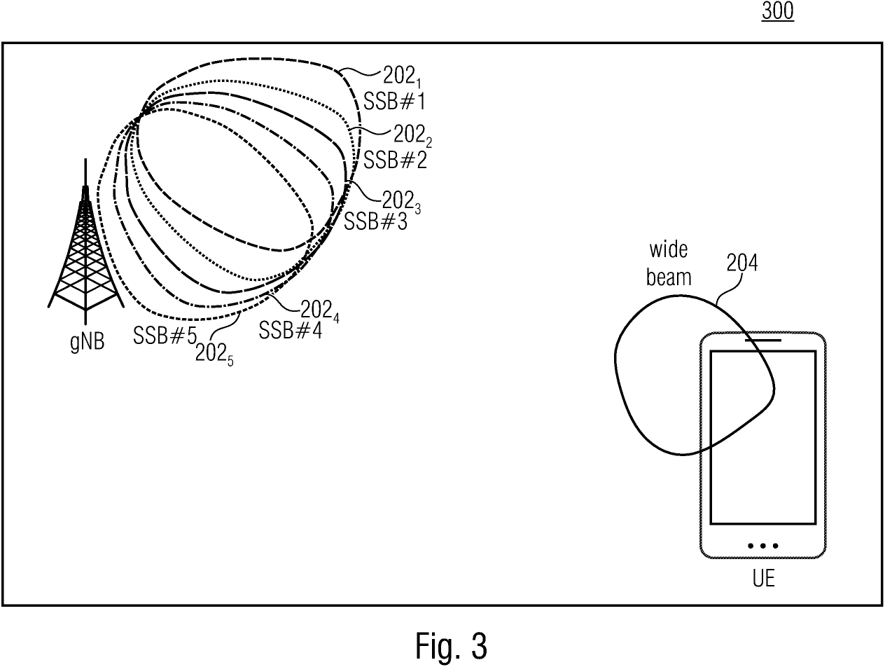

FIG. 3 is a schematic diagram of at least a part of a wireless communication network 300 in which a network node such as a base station or gNB forms a set of wide beams 202₁ to 202₅, e.g., transmitting synchronization signal blocks, SSB, 1, 2, 3, 4 and 5. Based on determining the beams 202₁ to 202₅, at least in parts, the UE may select a beam 204 to be formed as a response. For example, the beam 204 may be a transmission beam pattern or a reception beam pattern. For example, by having determined that the recognized beams 202₁ to 202₅ are of a wide characteristic, the UE may decide to respond with a wide beam 204. That is, FIG. 3 shows an example of a connection between two network devices, a gNB and a UE. The beam correspondence procedure is to be applied at the UE side: the gNB forms a transmit beam in a given direction and identifies/marks it with a signal identifier/reference symbol, here an SSB. The UE may make a selection from the set of SSB beams provided by the gNB. In the given example, the UE uses a wide beam in uplink as a response.

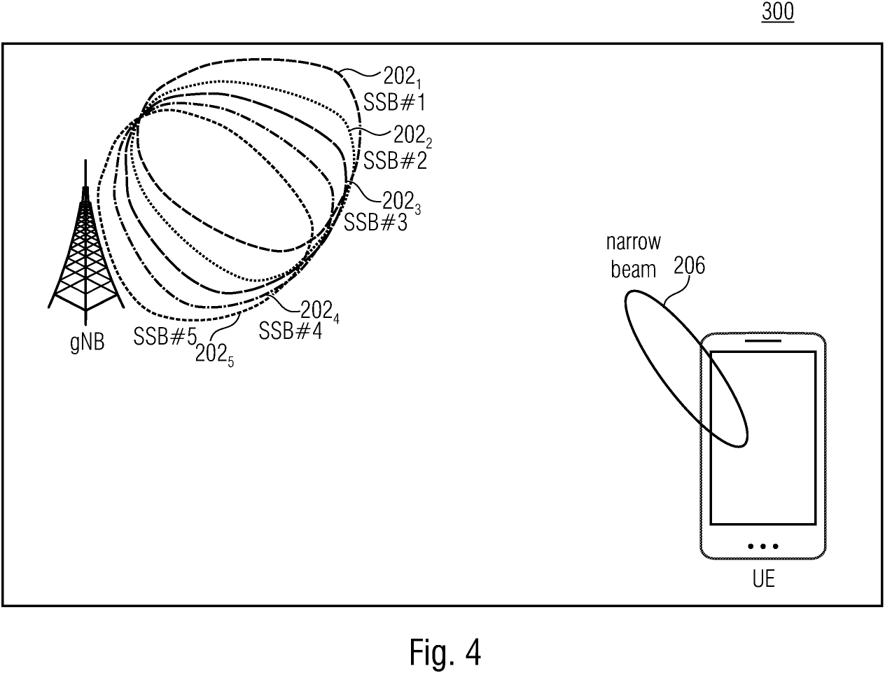

FIG. 4 is a schematic block diagram of the wireless communication network 300 in which the UE decides to use a narrow beam 206 responsive to having recognized the beams 202₁ to 202₅ or at least some of them, from the base station. That is, FIG. 4 shows an example of a connection between two network devices, a gNB and a UE. The beam correspondence procedure is to be applied at the UE side: the gNB forms a transmit beam in a given direction and identifies/marks it with a signal identifier/reference symbol - here an SSB. The UE makes a selection from the set of SSB beams provided by the gNB and uses a narrow beam 206 in uplink as a response in the example of FIG. 4.

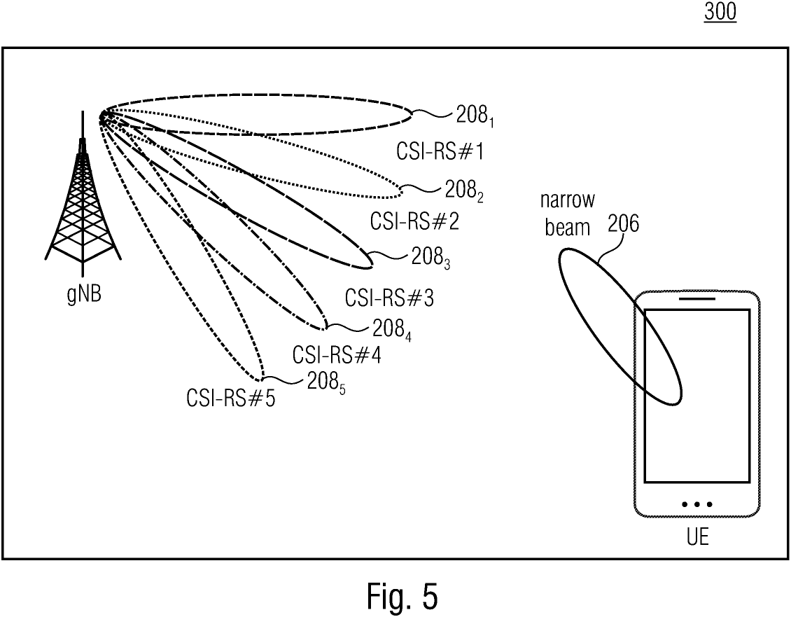

FIG. 5 is a schematic block diagram of the wireless communication network 300 in which the gNB transmits a narrow beam 208₁ to 208₅, e.g., as a channel state information, CSI, reference signal, RS, for each of the beams 208₁ to 208₅. The UE may decide to use narrow beam 206 as a response. That is, FIG. 5 shows an example of a connection between two network devices - a gNB and a UE. The beam correspondence procedure is to be applied at the UE side: the gNB forms a transmit beam pattern in a given direction and identifies/marks it with a signal identifier/reference signal - here a CSI-RS. The UE makes a selection from the set of CSI-RS beams provided by the gNB and uses a narrow beam 206 in uplink in the presented example.

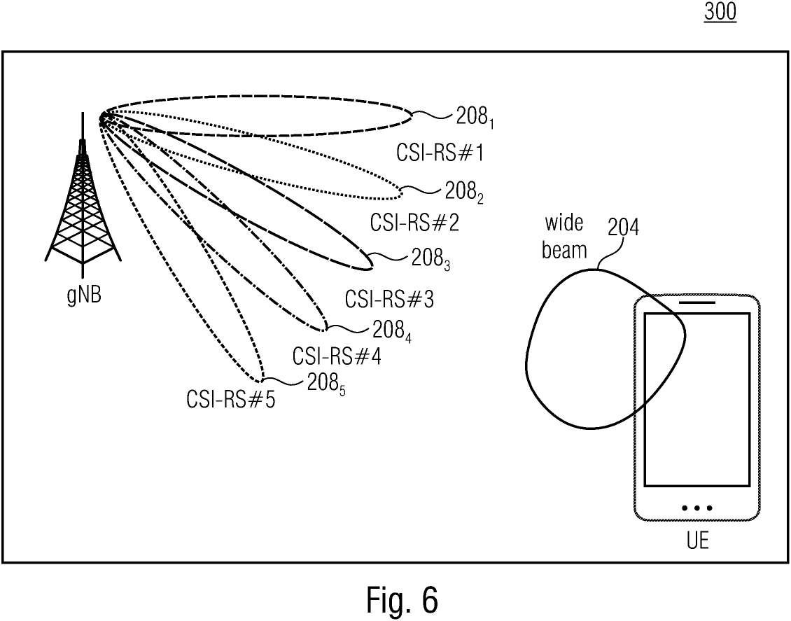

FIG. 6 is a schematic block diagram of the wireless communication network 300 in a scenario in which the gNB uses narrow beams 208₁ to 208₅ whilst UE decides to respond with wide beam 204. That is, FIG. 6 shows an example of a connection between two network devices - a gNB and a UE. The beam correspondence procedure is to be applied at the UE side: the gNB forms a transmit beam pattern in a given direction and identifies/marks it with a signal identifier/reference symbol/here a CSI-RS. The UE makes a selection from the set of CSI-RS beams provided by the gNB and uses wide beam 204 in uplink in this example.

It has been noted, that a number of beams to be transmitted, especially at the gNB-side, is chosen by way of example only and may deviate from the number of 5 so as to comprise any other number, e.g., 1, 2, 3, 4, 6, or a higher number.

In other words, FIGS. 3, 4, 5 and 6 provide examples of difference variants of kinds of RS input options in which the gNB provides wide beams - SSB as in FIGS. 3 and 4 and narrow beams - RS as in FIGS. 5 and 6. Further, beam pattern options transmitted by the responding device comprise to respond with a wide beam pattern as shown in FIGS. 3 and 5 or a narrow beam as shown in FIGS. 4 and 6.

It has to be noted that in the context of standardization 3GPP seems to have avoided to refer the definition of Beam Correspondence between a receiver beam of a device and the corresponding transmit beam of the same device to be linked or directly coupled to the property of channel reciprocity. Potential reasons include the assumption of non-identical placement/position of the transmit and/or receiver antenna array or non-reciprocal antenna pattern capabilities of the receive and transmit array. Furthermore, if reciprocal antenna patterns for the receive and transmit beam might be defined as a requirement, this would facilitate qualifying and reverse engineering embedded array capabilities and configurations using probing arrays and measuring their immediate transmit response. Therefore, many companies rather accept performance degradations than making their implementation to become transparent or public to avoid competitors to gain insight into another company’s implementation.

So far, beam correspondence was loosely defined such that the transmit beam pattern towards the communication partner should be good enough so the link will not break. Such weak requirement was able to find consensus in the technical specification, nonetheless it is rather suboptimum in terms of link and system performance.

Therefore, the inventors identified a way forward, keeping implementation specific variants proprietary without the need of sacrificing performance gains obtainable from beam correspondence behaviour coordination.

In the latter case, which is often referred to as beam correspondence, a transmit beam is selected by detecting a suitable receive beam. Together with an a priori knowledge and/or calibration, a transmit beam that best matches the directional pattern of the receive beam is selected.

To illustrate the importance of such mutual understanding the classical example of Singular Value Decomposition is chosen. The wireless MIMO channel can be decomposed into three matrices, U, S (or Σ), V, where U and V are unitary matrices used as spatial transmit and receive filters for the two ends of the link, while S is a diagonal matrix with power transfer coefficients on the diagonal, which describe the “pipe” capacity of the individual and parallel communication pipes.

In the traditional way, the two ends perform a full SVD algorithm which may be computationally complex and ambiguous. Furthermore, slight variations in the channel observation may create a mismatch between the input and output filters (U and V). Therefore, an alternative approach uses QR decomposition at each end and applying transposed Q as transmit filter. If both ends do this then the chosen Qs at each end will converge to U and V and therefore do an equivalent receive and transmit beamforming as needed for SVD, but fully distributed and capable of tracking channel changes by observing the changes with the receive filter and responding in the best approximative way with the transposed Q as a transmit filter.

In the before given example it is of utmost importance that the two ends know what algorithm is used at the other end, at least if the selected responses at both ends will lead to convergence in terms of spatial transmit/receive filter selection.

Therefore, in order to benefit from such convergence behaviour, the algorithms at each end and the selected transmit beams and RS precoding have to be coordinated. This can be done in a unilateral or bi-lateral fashion between the two communication partners.

Beyond the first given example of MIMO transmission using SVD by distributed alternatives using a pre-agreed beamforming arrangement at both ends of the link (transpose Q calculated at RX to be used as precoder over the same antennas) a second example should illustrate the validity of the proposed approach for a more general application scenario.

In the second example we assume the general case that a UE is requested to respond to a stimulus being a wireless signal transmitted from a communication partner e.g. a base station (BS) using pilots or reference symbols embedded in the transmitted sequence.

The BS has several options to create downlink beams towards the UE e.g. wider beams covering a larger area (often referred to as SSB beams) or narrow beams towards individual UEs within the coverage area of an SSB, wherein the narrow beams are usually referred to as CSI-RS beams. SSB and CSI-RS beams use independent and separate reference symbols embedded in the BS frame structure (in downlink), allowing a UE to differentiate between both inputs.

Since in practice wide beams (SSB) and narrow beams (CSI-RS) will be on-air (active) simultaneously, the UE has the task / opportunity to select which RS to exploit as stimulus for its response in order to avoid ambiguities.

To clarify the impact if there is no common understanding between the two communication partners the beam alignment and refinement procedure should be examined in more detail.

In an initial random-access phase, a UE is observing the emitted SSB beams from a base station, which as a set should cover the entire coverage footprint of the base station. If a particular SSB beam is detected to be the strongest, the UE will try to access the network starting the RACCH procedure on this particular SSB. It remains up the UE to choose a wider or a narrower beam to do so. That is, the network node may determine a plurality of signals, each forming at least a part of a potential stimuli. The network node may then select, from the plurality of potential stimuli, a selected stimulus as the stimulus to be responded to, i.e., to which it responds.

According to embodiments, the network node may receive information form the wireless network, the information indicating a priority list, an ordered list, a priority criterion or other assisting information that indicates to which stimulus the network node is requested to respond. The network node may rely on this assisting information but may also deviate therefrom and/or may ignore this information, e.g., if this would cause conflicts at the network node. Ignoring may, thus, be based on an active decision at the network node. Alternatively or in addition, the network node may inform the wireless communication network, e.g., the stimulating network node, about the stimulus to which it will respond or has responded or currently responds, i.e., about the selected stimulus. This may allow for an efficient operation of the wireless communication network.

For the sake of clarity, we define the DL beam pair to comprise the BS Tx beam and the UE Rx beam. Similarly, we define the UL beam pair to comprise the UE Tx beam and the BS Rx beam.

After network access has been granted by the BS, further beam refinement within the DL beam pair and/or the UL beam pairs might be needed in order to optimize link performance according to some metric / criterium. With currently known concepts this can be done to a certain degree within the framework of beam management and/or of beam correspondence at either end of the link.

During this procedure and during subsequent communication, both ends will observe the received signal and modify their transmit beam to keep track of the best link direction-this is called beam tracking. Within the framework of beam alignment, the base station can fine tune the narrow beams towards the UE (marked with CSI-RS) in order to provide a refined downlink stimulus. On the other hand, the UE could continue to respond to the SSB beam sent by the BS for various reasons and therefore ignore the purposefully fine-tuned stimulus provided by the CSI-RS beam. As a consequence, the beam alignment will not converge and tracking performance might be sub-optimum.

In order to ensure optimum beam refinement and tracking performance, both ends should agree on the stimuli/input signals and targeted output behaviour.

To the best knowledge of the inventors, such coordination mechanisms between the two communication partners regarding RS, precoders and algorithms for beam correspondence are currently neither available nor defined within the existing standard and are therefore proposed as enhancing method for better beam management and alignment mechanisms.

The inventors have identified a need and provide solutions for having a design of a mechanism which allows to orchestrate/influence the behaviour of algorithms and/or associated parameters/filters and/or reference signals/symbols used within them in order to better coordinate interaction between two wireless communication devices, e.g., a UE and a base station in terms of transmit/receive beam/panel/polarization selection and activation.

To differentiate from beam management, in a proposed approach, embodiments may influence the manner by which the UE:
Responds to particular stimuli e.g. RS or RSs
Responds with particular beams e.g. wide or narrow

Conventional Technology Example: currently BS can instruct the UE to create N SRS-beams in response to M CSI-RS (where N and M are not necessarily identical) beams. Subsequently, the BS instructs the UE which SRS-beams to use when the BS uses certain CSI-RS beams in downlink. That’s beam Management.

Embodiments allow the BS to influence the (semi-) autonomous response of the UE when creating, selecting, calculating its beams. For example, without such influence a UE may respond inappropriately according to the base station’s perspective. In other words, what would be the normal autonomous behaviour of the UE might in some situations be unacceptable / inappropriate. The current invention therefore proposes a way of influencing the UE so that it is responding more appropriately according to the base station’s request. End of D

### Standardization

To deal with the harsher propagation conditions at millimetre-wave (mmWave) frequencies (higher path loss, higher blockage by common materials such as foliage, brick and mortar, etc.) 5^{th} generation (5G) mobile networks employ high gain directional antennas (e.g. phased arrays). In order to achieve (near) unidirectional coverage, the directivity of these antennas has to be controlled by appropriate means, usually electronic (i.e., beam forming). Before mmWave devices in a 5G mobile network can communicate with each other, their respective antenna patterns (beams) have to be aligned (paired) with each other. To facilitate this, both the base station (BS, Next Generation Node Base Station gNodeB/gNB, Transmission Reception Point TRP) and the user equipment (UE) periodically transmit reference signals (RS). Reference signals can be used to identify beams. The BS’s downlink reference signals can be non-pre-coded Synchronization Signal Blocks (SSB) that can also be decoded by UEs not yet in a Radio Resource Control (RRC) connected state to that BS or user specific pre-coded signals (CSI-RS, Channel State Information Reference Signals). The SSB and CSI-RS signals are usually transmitted with different beamwidths (SSB are usually wide, CSI-RS are usually narrow). On the UE side, the uplink signals are called Sounding Reference Signals (SRS).

Two different techniques for beam alignment are currently defined by 3GPP and are being implemented: Beam Management and Beam Correspondence.

### Beam Management

Beam management (BM) is a technique where one of the communication partners, usually the UE, offers a set of marked beams and the other communication partner, usually the BS, measures and evaluates the received beams based on different metrics, for example Signal to Noise Ratio (SNR). The beam best suited for communication is then determined and the selection is communicated to the partner, which will then use that beam. While Beam Management is most commonly used for selecting the UE’s uplink beam, it is also applicable for the BS’s downlink beam(s).

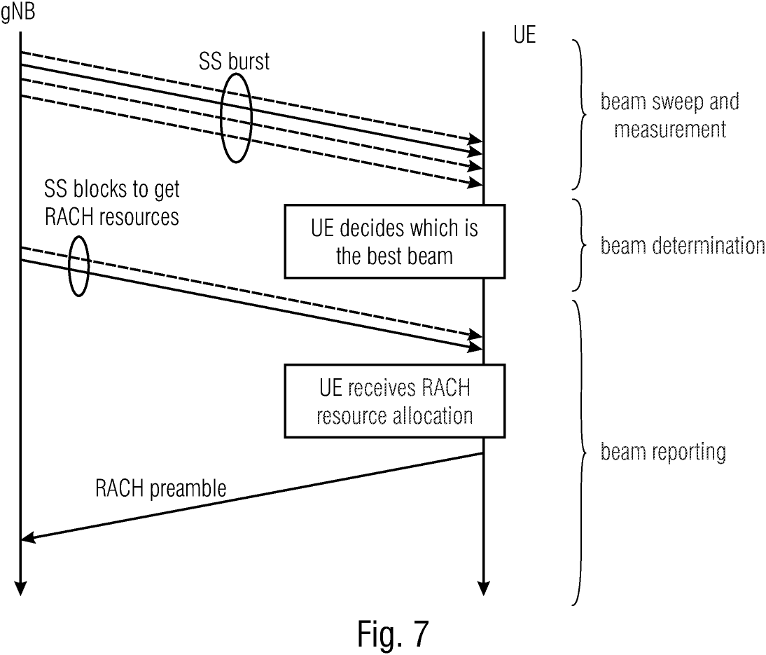

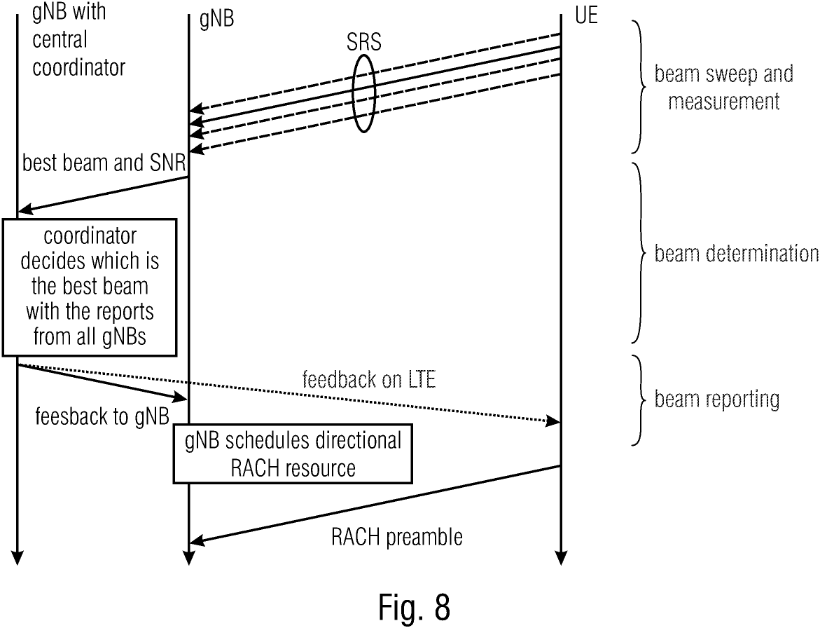

FIG. 7 is a schematic flow chart of signals and messages exchanged during downlink, DL, beam management, BM, procedures for initial access, IA. Further, FIG. 8 is a schematic flow chart of signals and messages exchanged during uplink, UL, beam management, BM, procedures for initial access, IA.

FIG. 7 shows the signals and messages exchanged during a downlink (DL) beam management procedure for initial access (IA) while FIG. 8 shows the messages exchanged during an uplink (UL) procedure. The figures also illustrate that the procedure can be divided into four different operations:
Beam sweeping: A spatial area is covered with a set of beams identified by their RS. Depending on the state of the communication, these beams can have different widths and can be pre-coded or not. During initial access for example, the BS would sweep with wide, non-pre-coded SSB beams. For beam refinement, the beams are usually much narrower and pre-coded for the specific communication partner, like CSI-RS. The sweeping process can be carried out with an exhaustive search covering the whole angular space or just a sub-space of the whole area.
Beam measurement: The quality of the received beam(s) is evaluated at the BS or UE according to suitable metrics, like SNR. A report table based on the channel quality of all received beams is compiled locally.
Beam determination: Based on the report table compiled in the previous step, the beam most suitable for communication is selected. During initial access, the receiving entity also selects its own beam for transmission in this step.
Beam reporting: The result of the previous step is transmitted to the communication partner who will then adjust its subsequent transmissions.

Beam management can be used both for initial access and for beam refinement in connected state for example to allow for mobility of the UE.

### Beam Correspondence

In order to minimize the overhead by several beam sweeps and associated reporting of the results, 3GPP has introduced Beam Correspondence in 3GPP TS 38 101, Section 6.6. This procedure allows the UE to autonomously select a suitable beam for UL transmission solely based on DL measurements.

Purpose of beam Correspondence feature: The transmit beam pattern should be selected to be a good match to the received angular power profile.

The UE can meet the beam correspondence requirements either fully autonomously (beamCorrespondenceWithoutUL-BeamSweeping = 1, as defined in [3GPP_TS_38_306]), or with assistance of the BS (beamCorrespondenceWithoutUL-BeamSweeping=0). In the latter case, the UE presents a set of deemed suitable beams to the BS which are then handled in a manner similar to beam management.

Although beam correspondence can be established on either SSB or CSI-RS signals, there is currently no standardized method from which the BS can determine the reference signal used by the UE when selecting its uplink beam.

In “Method and Apparatus for Beam Association between Downlink/Uplink” US 2018/0323855 A1, the general Beam Correspondence in Uplink process is described. A terminal (UE) receives a first (and second) information (CSI-RS, SSB or SRS) in downlink and selects a beam for uplink transmission based on the first information. The described method does not, however, enable the selection or prioritization of a specific first information (stimulus).

The second patent application relevant to this invention “Method for Transmitting/Receiving Uplink Channels in Wireless Communication System, and Device therefore” EP 3 567 783 A1 extends the general UL BC procedure with the possibility of transmitting the uplink signal via a plurality of beams. This applies to uplink sweeping, for example when the beamCorrespondenceWithoutUL-BeamSweeping bit is set to 0. Again, the described method does not enable selection/prioritization of the stimulus on which the uplink beam(s) are selected.

In the third patent application, “Initial Access in High Frequency Wireless Systems” WO 2016/086144 A1, a method for beam pairing during initial access is described. While the described method differentiates between broad and narrow beams, the beam pairing procedure depends on a beam sweeping or switching and does not enable a direct selection or prioritization of the input signal on which the output/uplink beam(s) are selected.

The fourth patent application, “Beam management with multi-transmission reception point multi-panel operation”, US 2020/0107327 A1, discloses a method of using independent beam management for a UE comprised of multiple antenna panels that are used to create a plurality of beams enabling parallel/simultaneous connections to one or more transmission reception points (TRP). The described method does not, however, enable the selection or prioritization of a specific first information (stimulus).

In the fifth patent application, “Communication method, system and related device”, EP 3 573 276 A1, a coordinated multipoint communication between network devices is disclosed. In certain situations, the plurality of transmission reception points can be described as being quasi-co-located (QCL). As this however is not true for all situations, QCL information is provided to the user equipment thus allowing for channel estimations from different antenna ports to be simplified when QCL is prevalent. The described method does not, however, enable the selection or prioritization of a specific first information (stimulus).

Thus, two general techniques for beam pairing between devices in a 5G mobile communication network exist: Beam Management and Beam Correspondence. In Beam Management, one communication partner has full control over the beam the other partner uses to transmit. This introduces a big overhead into the communication. With Beam Correspondence on the other hand, one communication partner can fully autonomously select its transmitting beam. According to the inventor’s literature research, no methods exist that guide the autonomous partner in Beam Correspondence with regards to the stimulus signal it uses for its own beam selection.

Further to the technical problem described, a potential technical solution is now described, which thus forms a basis for embodiments described herein. It is to be noted that although the examples presented in the following sub-sections are related to user equipment, UE, the invention disclosed herein is applicable to other network devices or network nodes not limited to include base stations such as BS, eNB, gNB, transmission/reception points, TRPs, integrated access and backhaul, EAP, nodes and the like.

In the following, the following sections are included:
Section 1 relates a hardware-oriented description of a network device to a conceptual system response model.
Section 2 introduces the concept of how to influence UE behaviour through the use of external means.
Section 3 the concept of a system that is responsive to stimuli and how matrices can be used to characterize the stimuli, the response and sensitivity of the system is presented.
Section 4 describes the topics of “responding to” and “responding with” and supports these with examples of the type of stimuli and responses that a UE might experience and exhibit.
Section 5 describes the methods and protocols needed to influence UE behaviour is given.
Section 6 discusses the various types of UE capabilities associated with sensitivity matrices.
Section 7 returns to the sensitivity matrix and describes its aspects in detail.
Section 8 introduces sets of matrices or matrix sets
Section 9 treats the topics of benchmarking and calibration.

### 1. Mapping Real Signal to the Input Vector and the Output Vector to the Beamformer

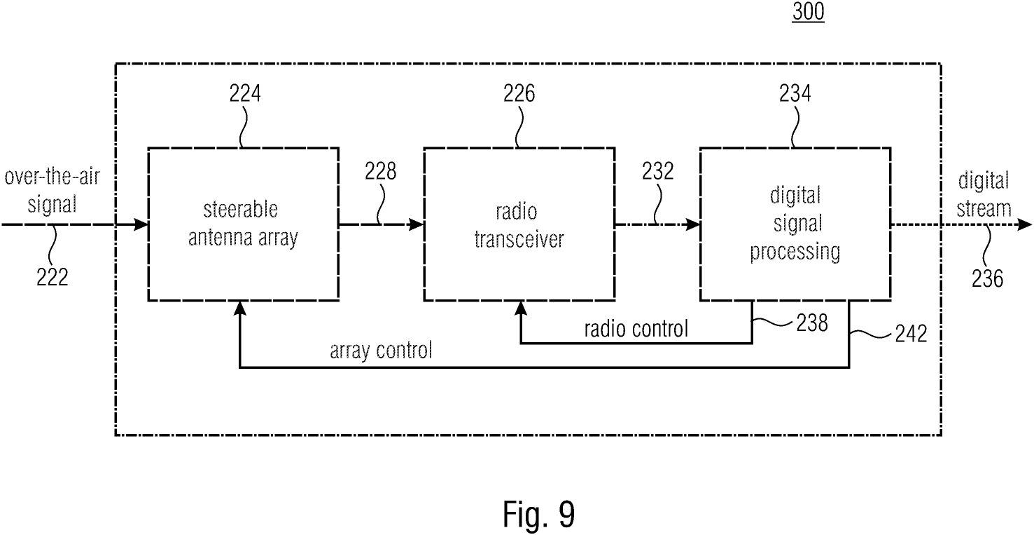

FIG. 9 shows a schematic block diagram of a network node 350 according to an embodiment. Network node 350 may be configured for receiving an over-the-air signal 222, i.e., a signal transmitted wirelessly. The network node 350 may comprise a wireless interface 224 such as a steerable antenna array for receiving the over-the-air signal 222. The wireless interface 224 may be connected to a radio transceiver 226 for providing an output 228 of the wireless interface 224, a processed version 232 respectively to a processing unit 234, e.g., a digital signal processing, DSP, unit. The processing unit 234 may output a digital data stream 236 that is based on the wireless signal 222. The processing unit 234 may provide control signals 238 to the radio transceiver 226 so as to control radio transceiver 226. Alternatively or in addition, the processing unit 234 may provide control signals 242 to the wireless interface 224 so as to provide for an array control, i.e., to control the steerable antenna array.

That is, FIG. 9 shows an example of a network device that is capable of steering a beam for use in a downlink reception whereby a digital stream comprising user plain and control plain information is received.

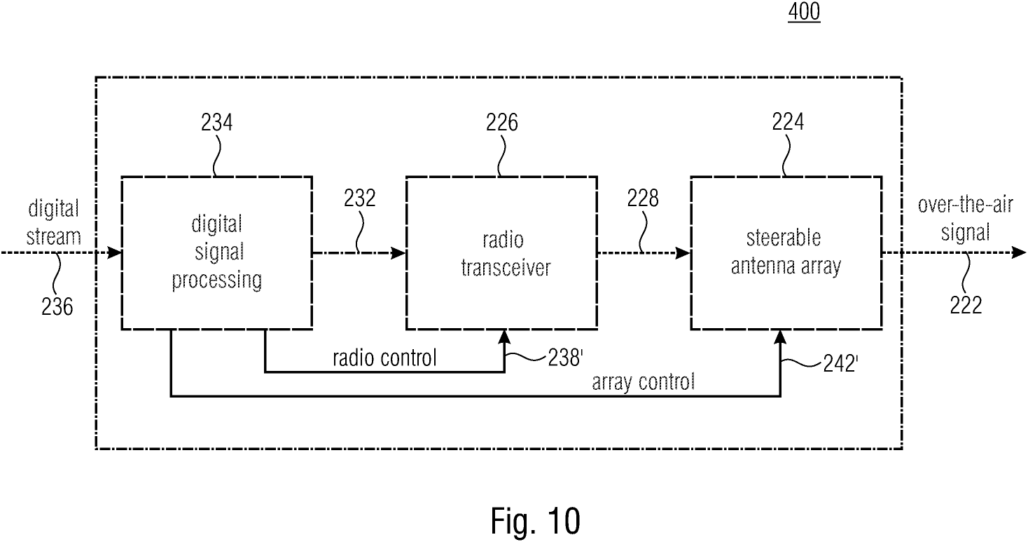

FIG. 10 is a schematic block diagram of a network device 400 according to an embodiment. Whilst network node 350 may operate as a receiver for receiving the over-the-air signal 222, network node 400 may operate as a transmitter. Network node 400 may comprise the wireless interface 224, e.g., the steerable antenna array, the radio transceiver 226 and/or the processing unit 234 as described for network node 350. However, operation is inverted in view of a sequence of processing steps. For example, the digital data stream 236 may be receiving and processed by the processing unit 234 so as to obtain signal 232 being an input for the radio transceiver 226, which may provide signal 228 as an input for the wireless interface 224. The processing unit 234 may control the radio transceiver 226 by providing control signals 238′ and/or may control the wireless interface 224 by providing control signals 242′.

An operation of a network node 350 may be combined with an operation or network node 400, i.e., network nodes according to embodiments may be implemented as a receiver, a transmitter, or as a combination thereof, i.e., as a transceiver.

As a preface to the topics listed above, consider a network device that is capable of forming and steering a beam in a needed direction. The device comprises a number of functions not limited to include a steerable antenna array, a radio transceiver and a digital processing unit. FIG. 9 and FIG. 10 provide examples of such a device being used for reception and transmission purposes, respectively. In the former, a beam is arranged to receive a signal that is sent over the air from another network entity from which, after certain stages of processing, a digital stream containing control plane and user plane information is made available for further processes. Conversely, in the latter, user plane and control information are formed into a digital stream that, and after certain stages of processing, is transmitted, over the air, towards another network entity. Examples of such network devices include base stations, user equipment and integrated access and backhaul nodes.

Based on the simplified hardware-orientated model presented above, the concept of a system that is responsive to a given stimulus (or stimuli) and thus responds with a certain response (or responses) will be introduced subsequently. It should be stressed that the implementation of such a conceptual system within any form of hardware realization is not the subject of the invention disclosed herein.

In other words, FIG. 9 shows an example of a network device that is capable of steering a beam for use in a downlink reception, whereby a digital stream comprising user plane and control plane information is received. Further, FIG. 10 shows an example of a network device that is capable of steering a beam for use in an uplink transmission whereby a digital stream comprising user plane and control plane information is transmitted.

### 2. Influencing UE Behaviour

When a UE does not have the means needed to respond to some form of external intervention, its response to a stimulus signal (for example; SRS, SSB and CSI-RS) will be made in either a fully autonomous or a semi-autonomous manner. In other words, the UE will act according to some configuration, method or mode of operation that is predefined and cannot therefore be easily changed from outside of the UE, especially not in a dynamic manner. In certain situations, including those discussed in Section 3, the performance of the communication link between the UE and one or more other network entities might be degraded. In order to therefore improve link performance, a method is proposed in which the UE is equipped with the means to accept additional signalling information through which its behaviour can be influenced.

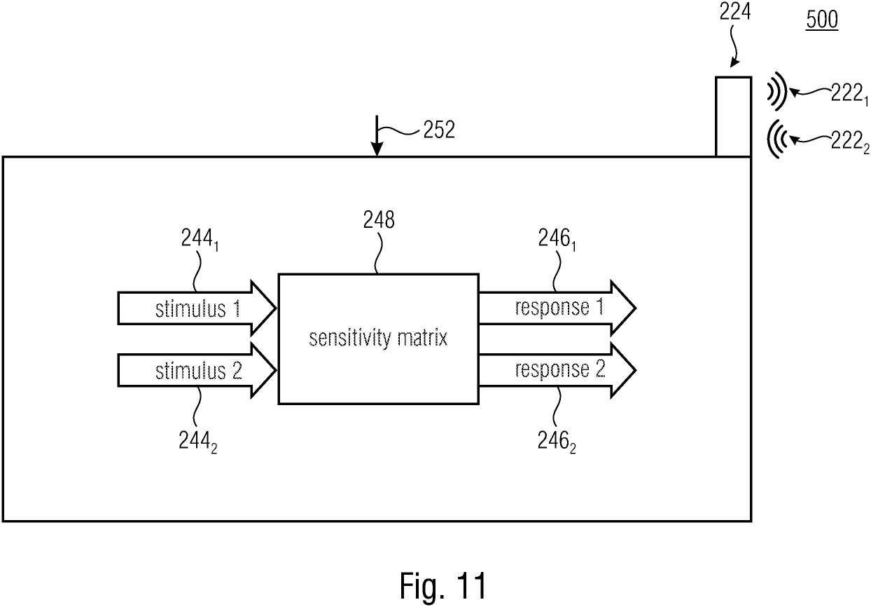

FIG. 11 is a schematic block diagram of a network node according to an embodiment. The network node is configured for wirelessly transceiving signals for operating in a wireless communication network. That is, network node 500 may transmit a wireless signal 222₁ and/or receive a wireless signal 222₂ when operating in the wireless communication network. The network node forms a response beam pattern responsive to a recognized stimulus which is represented stimulus beam pattern 244₁ and/or 244₂. The stimuli 244₁ and/or 244₂ may be formed as beam patterns by a stimulating node, i.e., another node or different node of the wireless communication network, for example, a network node that performs uplink or downlink communication with a network node 500 and/or P-to-P communication with a network node 500. Network node 500 may be, for example, a network node being served by a serving entity such as a UE or the like being served by a base station that may also be a serving network node.

The network node may select the response beam pattern as one or more of a type of stimulus recognised, e.g. and by making reference to the examples of stimuli above, a channel state information reference signal, CSI-RS, or synchronization signal block, SSB; a specific stimulus, e.g., a first SSB or a second SSB or a first SCI-RS or a second SCI-RS; and/or additional information such as information describing downlink beam characteristics not limited to include beam sweeping, beam tracking, static beam sets and so on.

However, whilst not limiting the embodiments to beam patterns, a stimulus is referred to hereinafter as a stimulus beam pattern but may also be indicated by a different stimuli or combinations thereof.

The network node 500 may form a response beam pattern 246₁ and/or 246₂ responsive to the recognized stimulus beam pattern 244₁ and/or 244₂. The stimulus beam patterns 244₁ and/or 244₂ may comprise, for example, a reception beam pattern and/or a transmission beam pattern of the stimulating node. The response beam pattern 246₁ and/or 246₂ may comprise, for example, a transmission beam pattern and/or a reception beam pattern. For example but limited hereto, the network node 500 may form a transmission beam pattern responsive to having recognized a reception beam pattern. Alternatively or in addition, the response beam pattern being formed may be a reception beam pattern being formed responsive to a stimulating transmission beam pattern. Alternatively or in addition, both the stimulus and the response may be a reception beam pattern or a transmission beam pattern.

What to do responsive to a recognized or determined stimulus 244₁ and/or 244₂ may be implemented, i.e., stored, encoded, programmed or the like, as a criterion 248. The criterion may describe an input-output relationship between the stimulus beam pattern being at least a part of the input and the response beam pattern being at least a part of the output. That is, the criterion 248 may form a basis for a decision, which responds 246₁ and/or 246₂ to implement responsive to the stimulus. It is to be noted that a number of stimuli and/or a number of responses may deviate from a number of 2. Both, the stimuli and the responses comprise a number of at least 2, at least 3, at least 4, at least 5 or even higher.

The network node 500 may receive a signal 252, the signal 252 indicating or comprising a request to influence, i.e., to change, modify, substitute or alter the criterion 248. That is, the network node 500 may influence, adapt, modify of substitute the criterion from a first criterion to a second criterion when changing the criterion. Network node 500 changes the criterion 248 based on the request, i.e., responsive to the signal 252. That is, by receiving the signal 252, a formed response may be different after having received the signal 252 when compared to a response that would be given to the same stimulus prior to receiving the signal 252. For example, the network node may influence the criterion 248 so as to adapt a result of a beam correspondence procedure being executed together with the stimulating node. That is a result of the beam correspondence procedure may be adopted based on adapting the criterion. Thereby, the input-output relationship may be modified based on the signal 252 indicating the request.

According to an embodiment, the criterion may be changed so as to adopt beam forming of the network node for a wireless communication with the stimulating network node. The signal 252 may be received from the stimulating network node or a different network node.

The network node 500 may receive the signal 252 as a part of a device configuration of the wireless communication network, e.g., by following a network setting/rule or by enabling or exploiting options to be activated or made accessible via APIs provided by the manufacturer of the device. However, signal 252 may also be received at any different time.

The criterion may be implemented as any rule, structure, set of instructions, pieces of code, hardware implementations or the like that allow for repeatedly providing a decision which response 246₁ and/or 246₂ to use based on a received stimulus 244₁ and/or 244₂. Although the embodiments are not limited hereto, embodiments described herein relate to a sensitivity matrix describing the criterion. It is to be noted that the embodiments may relate to network nodes that implement such a sensitivity matrix as the criterion 248 whilst, without any limitation, other ways of forming or determining the response may be implemented, for example, including if/then/else-rules case-selections or other ways of programming. Nevertheless, the sensitivity matrix forms an illustrative example of the embodiments described herein.

That is, the network node may influence the criterion to a modified criterion upon the request, a, signal 252. The response beam pattern may be a first response beam pattern and the network node may form at least a second response beam pattern responsive to the stimulus beam pattern using the modified criterion, i.e., a further but different response. Alternatively or in addition, the network node may form at least a second response beam pattern responsive to at least a second stimulus beam pattern within the same beamforming procedure or within a subsequent beamforming procedure being performed with the same stimulating node. The beamforming procedure may be, for example, a beam correspondence procedure.

### 3. Responding to Stimuli

A system which is receptive to one or more stimuli, provides a response according to the system’s sensitivity to the stimuli. The response can be related to each stimulus separately, all stimuli collectively or to a weighted combination of the stimuli. The system of FIG. 11 shows two stimuli as inputs and two responses as outputs. In general terms, the number of stimuli or system inputs (m) and the number of responses or system outputs (n) does not necessarily need to be identical only that there shall be a minimum of one stimulus or input and one response or output. Furthermore, when there is more than one input and/or output, these can be arranged as matrices or as vectors (matrices in which one dimension is unity). The system produces responses to stimuli according to the sensitivity matrix.

The generic model presented above is now described in terms of the following matrix definitions: the stimulus matrix, S; the sensitivity matrix A; and the response matrix R. Using these matrix definitions, the response of the system is defined as the matrix product:

$$\text{A S = R} \qquad \text{(1)}$$

Equation 1 shows how the sensitivity matrix acts on the stimulus matrix to form the response matrix. In order to form this product, dimensional requirements are imposed on the size of the three matrices whereby: A shall have dimensions of n-by-m (n-rows and m-columns); S shall have dimensions of m-by-r (m-rows and r-columns); and R shall have dimensions of n-by-r (n-rows and r-columns). These dimensional constraints are expressed in eqn. (2).

$$\left[\text{n-by-m}\right] \text{X} \left[\text{m-by-r}\right] = \left[\text{n-by-r}\right] \qquad \text{(2)}$$

In other words, FIG. 11 shows a generalized system whose response to stimuli is determined by the systems sensitivity matrix.

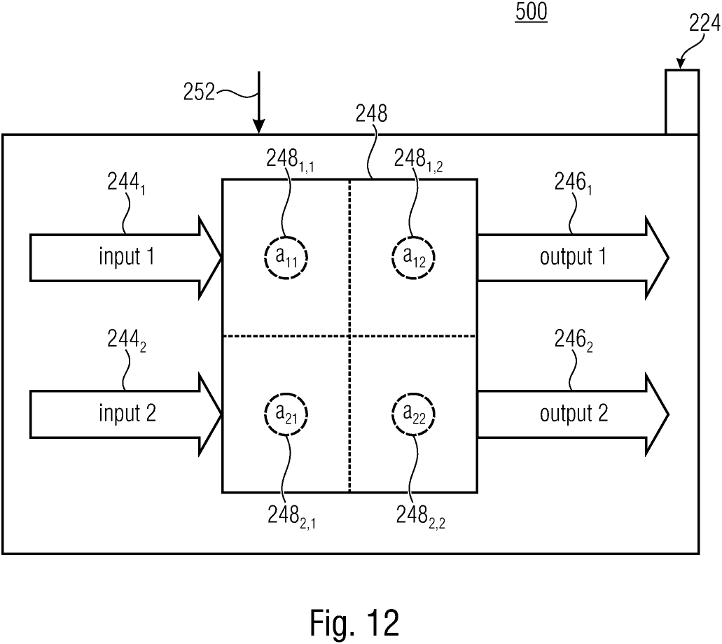

FIG. 12 shows network node 500 of FIG. 11 in a modified form, where the criterion 248 is implemented, at least in parts, by a set of partial criteria 248_{n,m}, where n relates to a line and m relates to a column of the sensitivity matrix. Partial criterions 248_{i,j} are illustrated as partial criterions a_{n,m}, i.e., a₁₁, a₁₂, a₂₁, and a₂₂ of the criterion 248. The number of two columns and/or two rows in the sensitivity matrix is, however, selected for being an illustrative example and may deviate from a number of two, without any limitation.

The different outputs 246₁ and/or 246₂ may relate to different types of beams, e.g., wide or narrow but may also relate to any different implementation of the response. For example, it may relate to channels and/or carriers to be used for the response. For example, the network node may determine the stimulus beam pattern as being mapped to at least one carrier such as a component carrier of the wireless communication network. The network node may form the response beam pattern on at least one same or different carrier and/or may determine the stimulus beam pattern as being mapped to a first channel of the wireless communication network and may form the response beam pattern on a different second channel set. That is, the response may deviate from the stimulus in view of at least one component carrier and/or channel. According to an embodiment, the network node may determine the stimulus beam pattern as being mapped to a carrier set of the wireless communication network and may form the response beam pattern to a different second carrier set in which at least one carrier is different from the first carrier. Between the carrier sets, a number of carriers may be the same or different. That is, the second carrier set may comprise an additional carrier or may have a carrier missing and/or may have other types of variations in the carriers. According to an embodiment, the network node may select a carrier for the response beam pattern based on a performance criterion, e.g., a throughput, a delay, a bit error rate, an interference-related ratio or the like. A set is to be understood so as to comprise at least one element of the set, i.e., a set of carriers comprises a number of one or more carriers, e.g., 1, 2, 3, 4, 5, 6 or more. A set of channels comprises a number of one or more channels, e.g., 1, 2, 3, 4, 5, 6 or more. Using a different set may relate to have a same or a different number in the different set.

For example, the network node may determine the stimulus beam pattern as being mapped to a plurality of carriers of the wireless communication network and may form the response beam pattern on only a subset of carrier or on all of the carriers. For example, the network node may receive information indicating a weighting between the carriers to be used for the response beam pattern and may select the carriers to be used based on the weighting. The weights may be determined, for example, at the base station, the base station thereby determining some sort or at least a part of the criterion. Thus, the weights may be a part of the instructions received with signal 252.

This mechanism may be implemented even if the network node is unable to change its criterion. That is, according to an embodiment, a network node configured for wirelessly transceiving signals for operating in a wireless communication network may form a response beam pattern responsive to a recognized stimulus beam pattern of a stimulating node, e.g., so as to respond to the response beam pattern. The network node may determine the stimulus beam pattern as being mapped to a carrier set of the wireless communication network and may form the response beam pattern on a different second carrier set. Alternatively or in addition, the network node may determine the stimulus beam pattern as being mapped to a first channel set of the wireless communication network and may form the response beam pattern on a different second channel set.

According to an embodiment, the network node may implement the criterion 248 as a plurality of partial criteria so as to provide for a weighted mapping of at least one input including the stimulus beam pattern to at least one output including the response beam pattern, wherein the network node is to adapt, based on the request, at least one partial criteria. The network node may implement the criterion to select the response beam pattern based on the stimulus beam patter and at least one additional parameter, e.g., a side constraint parameter such as a battery haul level of the network node, an amount of data to be transmitted or received and/or an operation condition of the network node. Alternatively or in addition, the network node may determine, based on the criterion, the response beam pattern at least one additional pattern parameter applying to the response beam pattern. For example, such an additional beam pattern related parameter may relate to at least one of a beamwidth of at least one lobe of the response beam pattern, a width of at least a null of the response beam pattern, a modulation coding scheme to be used for a signal transmitted with the response beam pattern and/or a frequency range in which the response beam pattern is formed.

That is, the additional parameter may relate to additional information to be considered such as a frequency of operation, a location, a temperature, an operator, a battery level, an operating power or the like. Optionally, the additional parameter may also for a t least a part of a constraint or relate hereto such as an operating power level not to be exceeded or a battery level not to drop below a minimum threshold.

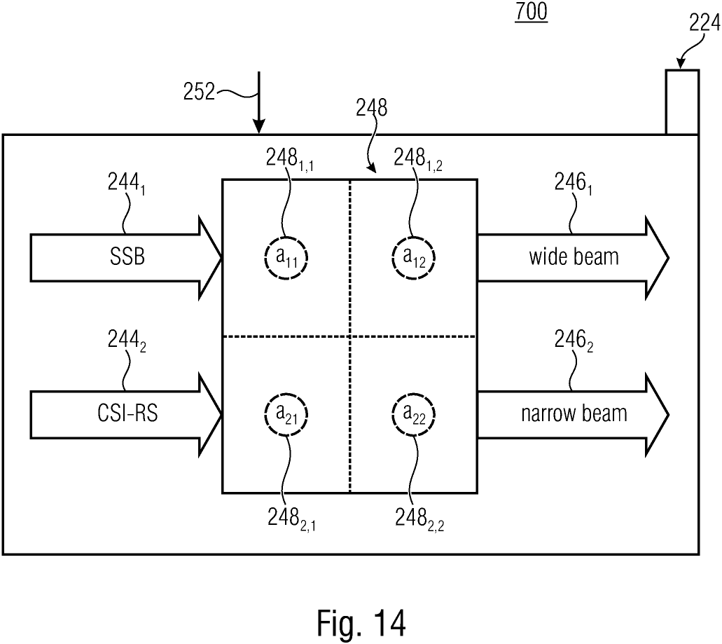

FIG. 12 thus shows a system comprised of two inputs and two outputs in which the sensitivity matrix has the dimensions to-by-to. FIG. 12 shows FIG. 11 in a modified form wherein the stimuli and responses are illustrated as inputs and outputs, respectively, and the sensitivity matrix is shown as being comprised of the matrix elements, a₁₁, a₁₂, a₂₁ and a₂₂. Since the sensitivity matrix has dimensions (n-by-m) of 2-by-2, both the input matrix (m-by-r) and the output matrix (n-by-r) need to have dimensions of 2-by-r (see for example FIG. 14 where the input and output are column vectors with dimensions of 2-by-1).

A square matrix in which all the main diagonal elements are 1′s and all the remaining elements are 0′s is referred to as an identity matrix, a unit matrix or an elementary matrix and is often written as I (the elements of an order-two identity matrix are a₁₁ = 1, a₁₂ = 0, a₂₁ = 0 and a₂₂ = 1). On the other hand, a square matrix which has 1′s along its counter-diagonal while all remaining elements are 0′s is called an exchange matrix, a reversal matrix or a backward identity matrix and is often written as J (the elements of an order-two exchange matrix are a₁₁ = 0, a₁₂ = 1, a₂₁ = 1 and a₂₂ = 0). We now consider the action of I and J on the 2-by-1 input vector S (comprised of the elements s₁ and s₂):

With reference to FIG. 12, we know consider the multiplication of the stimulus or input matrix, S, with the sensitivity matrix, A, to give the response or output matrix R for two special cases. In the first case, A = I and each input is mapped directly and fully to each output, i.e., r₁ = s₁ and r₂ = s₂. In the second case, A = J and the first input is mapped directly and fully to the second output as is the second input to the first output, that is i.e., r₁ = s₂ and r₂ = s₁. These two special cases are shown in equations 3 and 4.

$$\text{I S =} \left(\begin{matrix}1 & 0 \\ 0 & 1\end{matrix}\right) \left[\begin{matrix}{s}_{1} \\ {s}_{2}\end{matrix}\right] = \left[\begin{matrix}{s}_{1} \\ {s}_{2}\end{matrix}\right] \qquad \text{(3a)}$$

$$\text{J S =} \left(\begin{matrix}0 & 1 \\ 1 & 0\end{matrix}\right) \left[\begin{matrix}{s}_{1} \\ {s}_{2}\end{matrix}\right] = \left[\begin{matrix}{s}_{2} \\ {s}_{1}\end{matrix}\right] \qquad \text{(3b)}$$

An example of the application of a general sensitivity matrix, similar to that depicted in FIG. 12, is described in equation 4.

$$\text{A S =} \left(\begin{matrix}{a}_{11} & {a}_{12} \\ {a}_{21} & {a}_{22}\end{matrix}\right) \left[\begin{matrix}{s}_{1} \\ {s}_{2}\end{matrix}\right] = \left[\begin{matrix}{a}_{11} {s}_{1} + {a}_{12} {s}_{2} \\ {a}_{21} {s}_{1} + {a}_{22} {s}_{2}\end{matrix}\right] \qquad \text{(4)}$$

The above equation can also be expressed in a non-matrix form to show how, according to the elements of the sensitivity matrix, the stimuli are weighted and mapped to the response. This is shown in equation 5.

$$\begin{matrix}\text{R =} \left[\begin{matrix}{r}_{1} \\ {r}_{2}\end{matrix}\right] \\ \text{where} {r}_{1} = {a}_{11} {s}_{1} + {a}_{12} {s}_{2} {\text{and r}}_{2} = {a}_{21} {s}_{1} + {a}_{22} {s}_{2}\end{matrix} \qquad \text{(5)}$$

In the examples given, the stimulus or input matrix, S, may, however, be one vector or a combination of vectors. Same applies to the response matrix R.

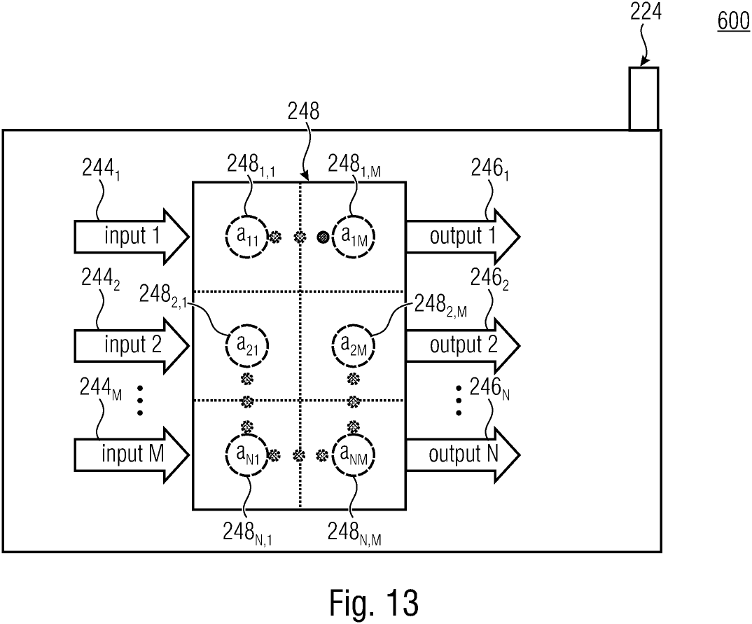

FIG. 13 is a schematic block diagram of a network node 600 according to an embodiment. When compared to network node 500, the criterion 248 may be represented as a NxM matrix having M columns and N rows so as to provide for N outputs 246 based on M inputs 244.

That is, FIG. 13 shows a more general case, in which the weighted mapping of one or more inputs to one or more outputs, may be obtained by suitably designing the sensitivity matrix at 248. For example, an M-input and N-output system, wherein the sensitivity matrix has dimensions of N-by-M. FIG. 13 thus shows a system comprised of M-inputs and N-outputs in which the sensitivity matrix has dimensions n-y-m. The inputs may comprise one or more stimulus beam patterns, i.e., parameters related to the stimulus beam patterns. Such inputs may comprise, for example, a gain, a power, a position and/or extension out of a main lobe, a side lobe and/or a null of the stimulus beam pattern, an identifier of the beam pattern or the like. This does not exclude further information or side constraints to form one or more inputs. For example, side constraints related to or associated with like a battery level may form at least a part of the inputs whilst, however, they are not considered to be a part of the stimulus matrix. For example, the response beam pattern may be determined together with additional information forming one or more outputs 246. For example, information such as if to use a wide or narrow beam may identify a response beam pattern at least in parts. Further, the sensitivity matrix may allow to determine side constraints such as a power level, a modulation coding scheme, MCS, a frequency of use or the like to use for the response beam pattern.

Besides changing the partial criteria, the request may, alternatively or in addition, indicate to influence the criterion so as to blacklist at least one response beam pattern, channel, or carrier from a set of possible response beam patterns, channels or carriers for which the network node is adopted. This may be implemented, for example, by naming or IDing or by setting values of the sensitivity matrix to a predetermined value, e.g., 0. Alternatively or in addition, the request may indicate to influence the criterion so as to ignore at least one stimulus beam pattern so as to avoid forming the response beam pattern responsive to the ignored stimulus beam pattern. That is, signal 252 may indicate to avoid specific outputs and/or to ignore specific inputs.

FIG. 14 is a schematic block diagram of a network node 700 according to an embodiment in which the stimulus 244₁ is related or identified to a class of beams received, e.g., a wide beam such as an SSB. Further, stimulus 244₂ may be, for example, a narrow beam such as a CSI-RS. Based thereon but not limited hereto, network node 700 may determine the response beam pattern so as to be a wide beam, e.g., beam 204, as response 246₁ and/or response 246₂ to be a narrow beam such as narrow beam 206. A selection or decision how to response on which kind of stimulus may be implemented in the criterion 248, the partial criteria 248_{n,m} respectively. By changing one or more of the partial criteria or the criterion 248 itself responsive to having received signal 252, the behaviour of network node 700 may be influenced.

In other words, FIG. 14 shows a UE system that is responsive to SSB and CSI-RS signalling information as inputs and provides either wide or narrow beams as outputs where the response is determined by a pre-defined sensitivity matrix. It has to be noted that the network node 700 may also form a combination of a wide beam and a narrow beam, e.g., both beams.

It has to be noted that the response vector and/or response matrix may comprise values that are normalized, e.g., having only one single non-zero value or having, in sum, a predefined value such as 1. However, embodiments are not limited hereto but may provide for any other structure such as a plurality of non-zero values, indicating possible or allowed responses from which the network node then selects a response that is to be implemented. However, such a selection, e.g., by use of a selection matrix may also be incorporated into the criterion 248, i.e., the sensitivity matrix.

That is, the stimulus beam pattern may be representable as at least an element of at least a stimulus vector, i.e., of a stimulus vector or a stimulus matrix. The criterion may be representable as a sensitivity matrix indicating a behaviour of the network node. Further, a combination of the stimulus vector/stimulus matrix and the sensitivity matrix may provide for a reaction vector indicating the response beam pattern. Changing the criterion may lead to a different response beam pattern based on a same stimulus vector, i.e., to different responses prior and after to reacting on signal 252. The request may be related to a request to change at least one element of the stimulus matrix.

Regardless if representing the behaviour of the network node as a sensitivity matrix, the network node may form the response beam pattern as a reproducible combination of input factors including at least one parameter of the stimulus beam pattern. For example, the combination may be a linear combination. Alternatively, the combination may also be a non-linear combination. The network node may implement the combination of input factors by implementing a sensitivity matrix and may use the input factors at least as an input factor for the sensitivity matrix so as to obtain a result vector, e.g., R or a part thereof, indicating the response beam pattern or providing for a basis of decision making for a selection of a response beam pattern. The criterion may relate to at least one matrix element of the sensitivity matrix.

The network node may implement the combination of input factors by implementing a lookup table or a weighting of the input factors in the combination, wherein the criterion relates to at least one weight of the weighting.

When referring again to the sensitivity matrix, the network node may implement the criterion as the sensitivity matrix that combines at least the stimulus beam pattern as a stimulus vector to obtain an output vector indicating the response beam pattern or forming a basis for a decision of the response beam pattern.

### 4. “Respond To” and “Respond With”

Based on the generalized systems presented in the figures above, a more specific example is presented in FIG. 12 in which a UE is illustrated responding to specific stimuli while responding with specific responses. The figure shows two types of (reference signal) inputs, SSB and CSI-RS, and two types of (beam related) outputs, wide beam and narrow beam. Without loss of generality, the UE shall respond to different inputs which can be classified by their type, can be specifically identified or are a combination of the two. Similarly, and again without loss of generality, the UE shall respond with different outputs which can be classified by their type, can be specifically identified or are a combination of the two.

The network node may form the response beam pattern as a first response beam pattern based on a first stimulus and may form a second response beam pattern based on a second stimulus beam pattern, the first stimulus beam pattern and the second stimulus beam pattern comprising a difference in view of their type, their identity or a combination thereof. A type may relate, for example, so as to be a wide or narrow beam, whilst an ID may relate, for example, to information contained in the signal. The network node may evaluate the first stimulus beam pattern and the second stimulus beam pattern for the difference or classification, e.g., with regard to a reference or with regard to the type, the additional information or the like, and may obtain an evaluation result and may consider the evaluation result in the criterion.

The network node may respond to the stimulus beam pattern as a stationary beam pattern and/or as a non-stationary beam pattern. The network node may provide the response beam pattern as one or more of:
a type of response, for example a wide beam or a narrow beam;
a specific response, for example:
   a wide beam pattern with its main lobe in a first direction or second direction; or
   a narrow beam pattern with its main lobe in a first or second direction; or
   a wide beam pattern with its main lobe in a first direction and a narrow beam pattern with its main lobe in a second direction; or
   a wide beam pattern with its main lobe in a first direction and a null in a second direction; or
   a narrow beam pattern with its main lobe in a first direction and a null in a second direction; or
   ◯ any combination of the above.

In other words, the UE can respond to an input which is at least one or more of the following:
a type of stimulus e.g. CSI-RS or SSB or;
a specific stimulus e.g. a first SSB or a second SSB or a first CSI-RS or a second CSI-RS; or
any additional information that the UE may or may not utilize (e.g. information describing downlink beam characteristics not limited to including beam sweeping, beam tracking, static beam sets and so on).

It should be further noted that a CSI-RS marked beams considered as a stimulus can be either:
Option A [Beam set is stationary]: composed of a set of fixed beams as in type-II feedback; the first device/node is creating a set of beams identifiable by CSI-RS markers to be transmitted as stimulus to the second device/node, wherein the set of beams the stimulus is kept fixed over a certain period of time, thus allowing the second device/node to observe relative changes in the propagation channel and respond accordingly with its own choice of response beamformers when transmitting to the first device. In case the first device/node is stationary (i.e., at a fixed location and/or orientation) and objects in the propagation environment are also stationary or are moving slowly, then this approach allows the second device/node to assess the effect of its own mobility/movements within the propagation environment by following the “fixed point” stimulus as a reference; or
Option B [Beam set is non-stationary]: BS is tracking the UE with a dynamic beam direction; in option B the first device/node is creating a set of beams identifiable by CSI-RS markers to be transmitted as a stimulus to the second device/node, wherein the set of beams (i.e., the stimulus) is tracking with respect to the main direction of the beam set, thus allowing the second device/node to observe the link towards the stimulus through the propagation environment, while the first device is directed towards the second device. The tracking/directing can be based on the response of the second device which can be considered as a stimulus for the first device from which it can compute and/or select a revised set of beams as a stimulus for the second device. Again, the second device responds with its own choice of response beamformers when transmitting to the first device. In case the first device/node is located at a fixed location while the second device is moving, then this approach allows the second device/node be exposed to the same set of beams/stimulus over a longer period of time. This allows simpler algorithms to be used and provides assistance for improved beam alignment convergence in both directions (DL and UL) in static and mobility scenarios.

Likewise, the UE can respond with an output which is at least one or more of the following:
a type of response, for example:
   a wide beam or a narrow beam;

a specific response, for example:
   a wide beam pattern with its main lobe in a first direction or second direction; or
   a narrow beam pattern with its main lobe in a first or second direction; or
   a wide beam pattern with its main lobe in a first direction and a narrow beam pattern with its main lobe in a second direction; or
   a wide beam pattern with its main lobe in a first direction and a null in a second direction; or
   a narrow beam pattern with its main lobe in a first direction and a null in a second direction; or
   any combination of the above.

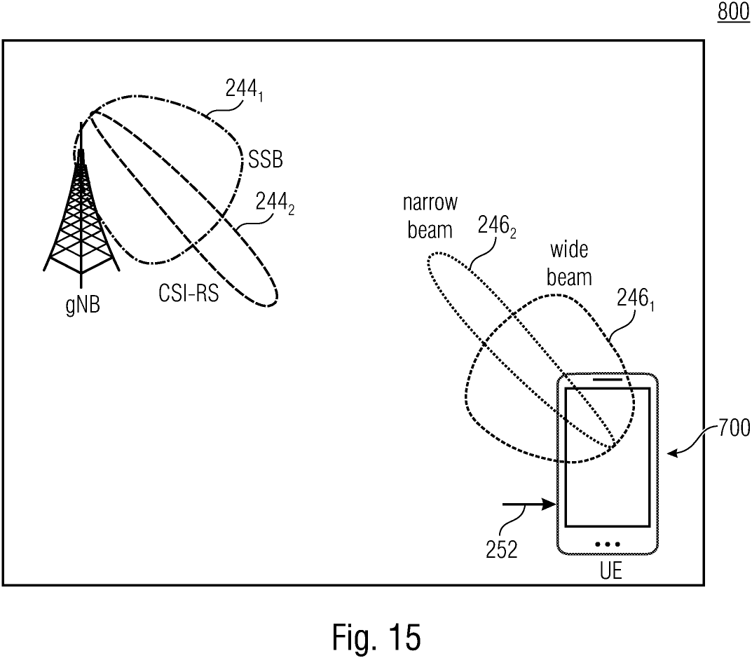

FIG. 15 is a schematic block diagram of a wireless communication network 800 according to an embodiment and being an alternative representation of the concept illustrated in connection with FIG. 14. A base station gNB may use, for example, either a wide beam SSB signals as the stimulus 244₁ or a narrow beam and CSI-RS signals as the stimulus 244₂ to influence the behaviour of the UE 700 so that UE 700 may respond with either a broad, wide beam 246₁ or a narrow beam 246₂. Although FIG. 15 shows both the gNB and the UE having both wide and narrow beams, at least in some embodiments, it may be unlikely that both beams may be used simultaneously. For example, stimulus 244₁ may be beam 202 whilst narrow beam 244₂ may be beam 208. For example, wide beam 246₁ may be beam 204 whilst narrow beam 246₂ may be narrow beam 206.

The criterion according to which UE 700 selects how to response to stimulus 244₁ and/or 244₂ may be adapted, for example, by receiving and processing a signal 252 which may be transmitted, for example, by a higher authority such as a network controller, by a base station such as the illustrated gNB and/or a different network node.

In other words, FIG. 15 shows a scenario in which through the use of a stimulus signal, either SSB or CSI-RS, the gNB may influence the behaviour of the UE such that it responds with either a narrow beam or a wide beam. Although two different beams are shown for each device, it is unlikely that they would be used simultaneously in practice.

At this stage, it has been noticed that for wireless communication network 800, the signal 252 may be optional.

Although the behaviour of the UE may be influenced, it may also be the case that the gNB or a different kind of network node configured for wirelessly transceiving signals for operating in a wireless communication network determines, has knowledge or otherwise obtains a favourite beam pattern of the responding network node, e.g., network node 700. That is, the gNB may have knowledge about a way it favours the responding network node to respond. The gNB has access to a memory having stored thereon information indicating different responses of the responding network node responsive to different stimulus beam patterns. For example, it may have knowledge about the criterion and/or parameters or information indicating the criterion implemented in the network node 700. The gNB may select a stimulus beam pattern it uses based on the favourite beam pattern, e.g., based on the desired response. The network node may transmit the selected stimulus beam pattern, e.g., stimulus 244₁ or 244₂ so as to provoke the responding network node 700 to generate the favourite response beam pattern. Alternatively or in addition, the gNB may instruct a further, different network node being not illustrated in FIG. 15 to use the selected stimulus beam pattern so as to provoke the responding network node to generate the favourite response beam pattern. That is, a network node that has knowledge about the response the UE will give, may instruct a different network node so as to operate so as to provoke the network node to respond as desired.

In such a configuration, signal 252 may not be necessary such that a respective configuration may also be implemented for devices that are operated in an operating mode that does not allow or support to amend or influence the criterion.

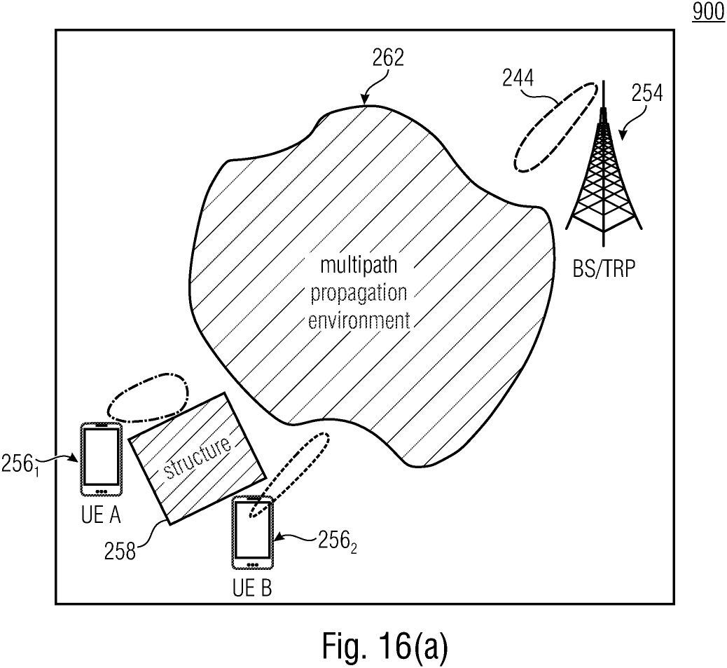

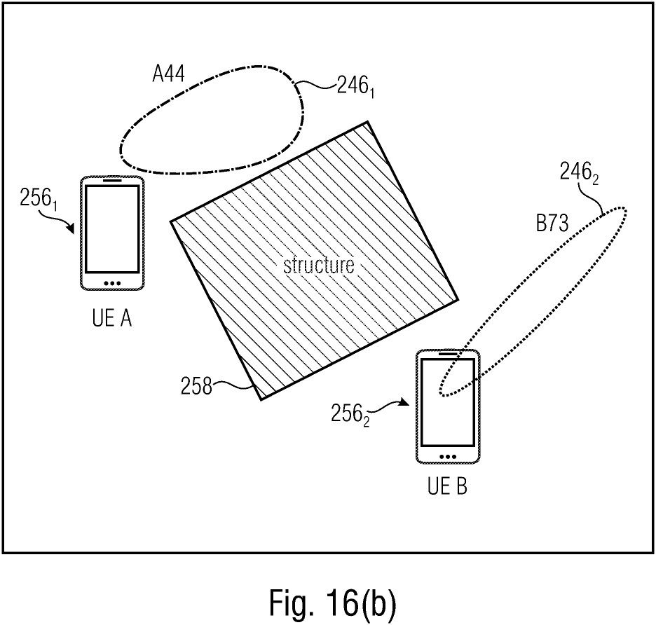

FIG. 16a is a schematic block diagram of a wireless communication network 900 according to an embodiment. Wireless communication network 900 comprises a network node 254 operating as a base station and/or transmission/reception point, e.g., the gNB of wireless communication network 800. Furthermore, network nodes 256₁ and/or 256₂ are arranged, e.g., operating as network nodes 350, 400, 500, 600, and/or 700, wherein, in general, the network nodes 256₁ and/or 256₂ may be implemented so as to operate in accordance with signal 252 or not.

In FIG. 16a, two network nodes 256₁ and 256₂, e.g., implemented as UEs, are placed either side of a large structure 258, for example, a building or the like, and have established communication with a distant base station, the network node 254 through a multi-path propagation environment 262. That is, FIG. 16a is an example of two UEs positioned either side of a large structure 258 and communicating with a base station 254. The radiation patterns associated with all devices have been greatly simplified.

A closer examination of FIG. 16a is presented in FIG. 16b showing a part of the wireless communication network 900. In FIG. 16b it is shown that UE 256₁ is communicating with a beam pattern which is somewhat broader than that associated with the beam pattern of UE 256₂. By way of example, UE 256₁ may reply with response 246₁ (wide beam) whilst UE 256₂ may respond with response 246₂ (narrow beam). The UEs 256₁ and/or 256₂ may use a means to mark or identify their beams as indicated by “A44” and “B73” respectively, e.g., as part of a specific response. The content of this information is selected for illustrated the example only, and does not limit the scope of the embodiments. To the contrary, any type of information and/or identifier may be incorporated. That is, FIG. 16b shows a detailed view of FIG. 16a showing the two non-co-located UEs responding to different stimuli, wherein UE 256₁ responds with a relatively broad beam identified A44 and UE 256₂ responds with a relatively narrow beam B73.

When referring again to FIG. 16a, the network node 254 may provide a first stimulus for one of network nodes 256₁ and 256₂ and a further, different stimulus to the other network node 256₂, 256₁ respectively, so as to obtain the different response. Alternatively, the wireless communication network 900 may cause at least one of the network nodes 256₁ and 256₂ to adopt the respective criterion, e.g., sending a signal 252, such that the network nodes 256₁ and 256₂ may respond differently when receiving the same stimulus 244, regardless if they are co-located or not.

As described, a network node may provoke a responding network node to form a desired, favoured response beam pattern by amending its own stimulus ort by instructing a stimulating network node accordingly, i.e., to amend the input of the input-output-relationship. Alternatively or in addition to provoke a network node to correspond based on an unchanged criterion, the network node may also request for a change of the criterion, e.g., trigger transmission of signal 252. Such a network node configured for wirelessly transceiving signals for operating a wireless communication network may transmit a signal indicating a request, to a responding network node to influence the respective criterion according to which the responding network node selects a response beam pattern as a response to the stimulus beam pattern.

The network node may determine a favourite response behaviour of the responding network node and may generate the request to influence the criterion so as to result, when compared to a first response beam pattern with the unchanged criterion, in a changed second response beam pattern generated by the responding network node, such that the first response beam pattern and the second response beam pattern differ with respect to each other and when responding to the same stimulus beam pattern.

Such a network node, e.g., a base station, may generate the request so as to indicate one criterion over a plurality of criteria for determining the response beam pattern. The plurality of criteria may be predefined at the responding network node, e.g., when referring to UE type #2.

Such a network node may generate the request so as to request the responding network node to form the response beam pattern on only a subset of carriers, a different set of carriers and/or a different set of channels or, alternatively, on all the carriers of a set of carriers of the wireless communication network to which the stimulus beam pattern is mapped.

The network node, e.g., the base station, may determine a weighting of the carriers and/or channels to be used for the carriers to which the stimulus beam pattern is mapped. The network node may apply the weighting in the request and/or may provide the weighting to the responding network node so as to indicate, how the responding network node should determine its selection.

The network node may generate the request to influence the criterion so as to request programming of a new criterion at the responding network node and for applying the new criterion for determining the response beam pattern. This may implement for setting, i.e., programming, one, more or all of the partial criteria.

The network node may have access to information indicating a structure of partial criterions of the responding node and may generate the stimulus beam pattern so as to result in a favoured beam pattern selected by the network node based on the structure of partial criterions. That is, the requesting node may consider the dimension of the sensitivity matrix.

Network node may have access to information indicating a structure of partial criterions of the responding node and may generate the request so as to request a change of at least one partial criterion. A partial criterion may implement a weighting within a selection procedure of the responding node to select the response beam pattern from a plurality of possible beam patterns. The network node may generate the request to modify the weighting.

The network node that may form the request may receive an institution signal containing information indicating instruction to cause at least one responding network node to respond with a favourite response beam pattern or to change a criterion according to which the responding network node selects a response beam pattern and may operate according to the instructions. This may allow to implement wireless communication networks that have been orchestrating the behaviour of network nodes such as UEs.

It may be expected that the means by which the UE detects and identifies a stimulus and, similarly, the means by which a UE produces its beam pattern as a response will be implementation specific. Since implementation specifics are likely to be proprietary to the vendor of the UE, such aspects may be implemented in a known manner.

### 5. Method and Protocol

The following description will outline a method and associated signalling to implement a feasible way to influence the response behaviour of a device supporting the beam correspondence feature. In particular this sub-section describes a) the methods by which and b) the protocols through which the base station delivers stimulus information to the UE and c) how sensitivity matrices can be selected and adjusted.

Assuming that knowledge about a kind of sensitivity matrix, describing the input-output relationship of the beam correspondence mechanism used by a device is available to another device or entity then such a sensitivity matrix could be considered as:
Option A: A specific matrix /configuration known by or shared with another device/entity
Option B: One matrix out of a set of matrices applied at the device using BC to describe configurations of the BC feature.

In the options above the sensitivity matrix in the UE can be influenced by the base station by using a kind of index pointing towards a specific matrix of the set (option B). This is similar to PMI feedback from the influencing entity (base station) and would correspond to a type I CSI feedback mechanism. Alternatively, the beam correspondence behaviour can also be influenced by providing a PMI and, in addition, scalar or complex multipliers to be applied to matrix elements (e.g. rows, columns, quadrants, areas). This feedback mechanism can be applied to one or more sensitivity matrices which should be used by the influenced device (UE) in sequence or as a superposition/combination and/or provide/requested choice. This is similar to a type II CSI feedback.

A further implementation option is described in the following. The device is sharing a set of sensitivity matrices and associated indexing with the influencing entity/device (base station). The set of sensitivity matrices and the associated indexing can be:
Known a priori by e.g. indicating a specific type of beam correspondence capability or encoded into the device by a preconfigured setting e.g. by a software specific release or mandated by a standard
set at a specific stage of device configuration e.g. by following a network setting/rule or by enabling/exploiting options to be activated/made accessible via APIs provided by the OEM of the device.

If both the set of sensitivity matrices and the associated indexing/pointing is known to the influencing device/entity (base station), then the desired BC behaviour can be selected/influenced by sending an index (e.g. PMI) describing the requested matrix to be applied.

As an alternative, matrix selection can be done implicitly by providing indices to behaviour description matrices. Here, the meaning is known a priori by the device (UE) for example through the use of standardized matrices such as an identity matrix or a backwards identity matrix.

### 6. Capabilities

We recall from Sect. 0 that the response of the UE to a stimulus is a function of both the stimulus itself and the sensitivity matrix of the UE. Methods are thus described which make use of either or both of these and, where appropriate, compensate for any effects resulting from their implementation or realization. It is implicitly assumed that the UE has the means to be influenced by an external source and therefore that its capability of doing so is known to the base station. Furthermore, and as it will be shown that some UEs may have a greater or lesser means to be influenced externally, a capability classification might also be made available to (or is otherwise known by) the base station.

### 6.1 UE-Type#1

The simplest form of UE whose behaviour can be influenced externally, contains a single and pre-defined sensitivity matrix whose elements are fixed and cannot therefore be changed. In order for such a UE to be influenced using external means, and recalling the discussion of Section 2 and in particular eqn. (2), it is needed that the BS has knowledge of the dimensions of the UE’s sensitivity matrix. This enables the BS, using suitable means, to either directly create a stimulus matrix with the appropriate dimensions or to generate the needed signalling means from which the UE can construct the needed stimulus matrix.

### 6.2 UE-Type#2

A more advanced form of UE (whose behaviour can be influenced externally) might contain a multiple number of pre-defined sensitivity matrix whose elements are fixed and cannot therefore be changed. As before, it is needed that the BS has knowledge of the dimensions of the UE’s sensitivity matrix so that it can use suitable means, to either directly create a stimulus matrix with the appropriate dimensions or to generate the needed signalling means from which the UE can construct the needed stimulus matrix. In addition, the BS can request the UE to use one of the predefined sensitivity matrices without needing to know the contents of the matrix on an element-wise basis. In other words, the BS only needs to have knowledge of the number and types of sensitivity matrices that the UE supports. This enables the BS, using suitable means, to request the UE to use a given stimulus matrix. As it is conceivable that some UEs may be able to offer more pre-defined sensitivity matrices than other UEs, this information should be made available to the BS through some form of capability signalling.

### 6.3 UE-Type#3

An even more advanced form of UE (whose behaviour can be influenced externally) might have the means to accept one or more sensitivity matrices from another network entity, for example a basestation. As before, it is therefore needed that the BS has knowledge of the dimensions of the UE’s sensitivity matrix so that by using suitable means, it can provide both the UE with a suitable stimulus matrix of the appropriate dimensions or provide the needed signalling means from which the UE can construct the needed stimulus matrix. Furthermore, the BS also needs to have knowledge of the appropriate matrix dimensions so that it can signal the contents of the sensitivity matrix to the UE. The BS may use different forms of signalling means though which to supply information containing or describing the sensitivity matrix to the UE, examples of which include the use of: direct signalling; embedded signalling; or the use of a separate channel which might run over-the-top of other channels.

### 6.4 UE-Type#4 as a Combination of UE-Type#2 and UE-Type#3

Certain UEs might have the added flexibility of using multiple pre-stored matrices, reconfigurable matrices or combinations of the two. Again, such UEs shall provide the BS with information related to the capabilities of the “dimensions” they support and their flexibility-static, dynamic or hybrid.

### 6.5 UE-Capability#1

An additional UE capability, applicable to all of the aforementioned types, is the ability of some UEs to (semi-)autonomously respond to defined conditions, for example: triggers; thresholds; events, counters; timers; and so on.

### 6.6 UE-Capability#2

A further additional UE capability, applicable to the reconfigurable UE, e.g., UE-type#3 and/or UE-type#4 is for the currently used sensitivity matrix to be manipulated by some means that include a) a direct external influence (for example a set of correction factors supplied by the BS or some other network connected device) b) as a (semi-)autonomous response to certain pre-defined conditions (for example: triggers; thresholds; events, counters; timers; and so on) or c) as a combination of the two.

### 7. Sensitivity Matrices

Although some of the following concepts were introduced in earlier sections, they are collected here under one heading for convenience.
Matrix dimensions should be consistent, involving a priori exchange of knowledge of matrix dimensions between the UE and the BS.
UE should signal dimensions of input and/or output (exchange of dimension updates should be supported by the protocol) AND
Possible and impossible matrix structures (masking which matrix elements are fixed and cannot be changed OR only in relationship with other elements)
Matrix elements are (pre-) configured with weights on inputs and outputs
Combinations are formed from matrix element weights and from matrix priorities and can be activated (recalled) according to defined criteria or conditions. Thus, the notion of conditional matrix behaviour/activation/selection.
The UE shall respond to the above information accordingly wherein the implementation is UE specific and possibly propriety.
Matrices can be cascaded.
A device may or may not provide information about its sensitivity matrices.
The network may or may not provide information to other users about the sensitivity matrices sent to a device.

### 8. Matrix Sets

The set of matrices is configured or pre-set/stored/UE-defined and exchanged with the BS
UE capabilities will describe the number and structure of the matrices.
UE can signal priorities, settings and preferences.
UE can signal while MODE is active.
Priorities are assigned to matrices that form a set of matrices.

### 9. Sensitivity Matrix Benchmarking and Calibration

In order to obtain an understanding of the manner in which the UE interprets a given sensitivity matrix, two procedures are proposed.
Proposed procedure #1:
   ◯ The first device (e.g. the BS) requests the second device to respond to a given stimulus sent from the first device using a) the identity matrix I and b) the reverse identity matrix J.
   ◯ Based on the response of the 2^{nd} device to, the 1^{st} device adapts its stimulus OR recalculates a new sensitivity matrix to be transferred to 2^{nd} device.
Proposed procedure #2:
   ◯ The first device (e.g. the BS) requests a response to one or more matrices which have been selected by the second device (e.g. the UE). The matrices selected by the 2^{nd} device are shared with the 1^{st} device.
   ◯ Based on the response of the 2^{nd} device to a given stimulus, the 1^{st} device calculates and sends an “adapted matrix” to the 2^{nd} device. In essence, the response of the 2^{nd} device has been calibrated by the 1^{st} device.

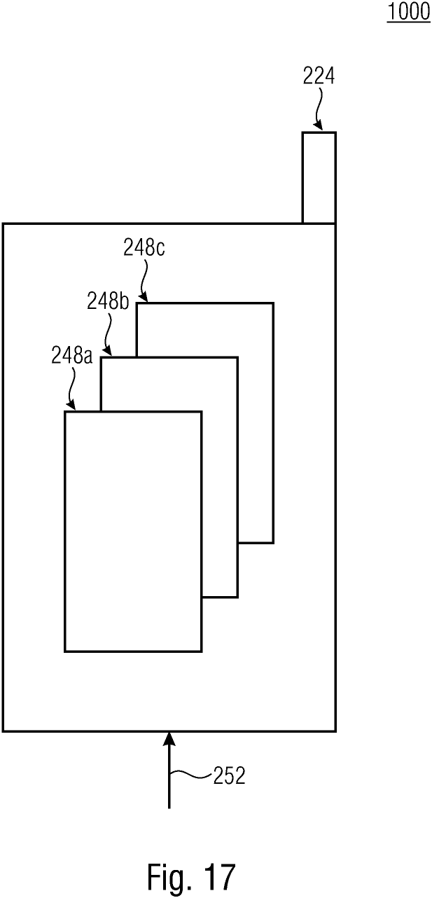

FIG. 17 shows a schematic block diagram of a network node 1000 according to an embodiment. Network node 1000 may implement, at least in parts, a functionality of UE-type #2 and/or UE-type #4. That is, the network node 1000 may selectively use one of a plurality of pre-defined criteria 248a, 248b and/or 248c, wherein a number of pre-defined criteria may be nay number larger than 1, for determining the response beam pattern. The network node 1000 may receive the request, e.g., as the signal 252, indicating one criterion 248a, 248b or 248c of the plurality of criteria as a requested criterion. The network node 1000 may use the requested criterion so as to follow the request.

Alternatively or in addition, when referring again, for example, to FIG. 12 or FIG. 13, the signal 252 may indicate to amend one or more partial criteria such that the criterion itself may remain unchanged and only a part thereof may be influenced or changed. That is, the network node may use the criterion as a set of partial criterions and may receive the request so as to indicate at least one partial criterion and to apply the criterion based on the at least one indicated partial criterion for determining the response beam pattern. That is, the signal 252 may indicate the partial criterion and/or may indicate a rule, request or the like on how to amend a partial criterion. Both ways result in a partial criterion that is implemented according to the request.

That is, the network node 1000 may comprise a plurality of pre-defined sensitivity matrixes. Network node 1000 may select one of the plurality or a specific combination of the plurality of sensitivity matrixes based on the request. Such a combination may be a linear and/or weighted combination that may be indicated, for example, in a respective operating mode and/or a received request signal. Thus, a selection of one of the plurality of criteria 248a to 248c or of the specific combination of the plurality of sensitivity matrixes may be based on the request 252. The network node may comprise at least one sensitivity matrix and may influence or change at least one element of the sensitivity matrix responsive to the request as an alternative or in addition hereto. Thereby, the network node may select one of a plurality of response beam patterns formable with the network node, i.e., one of the possible responses, based on the stimulus beam pattern. The network node may select a different response beam pattern responsive to the same stimulus beam pattern after changing the criterion when compared to a situation prior to changing the criterion.

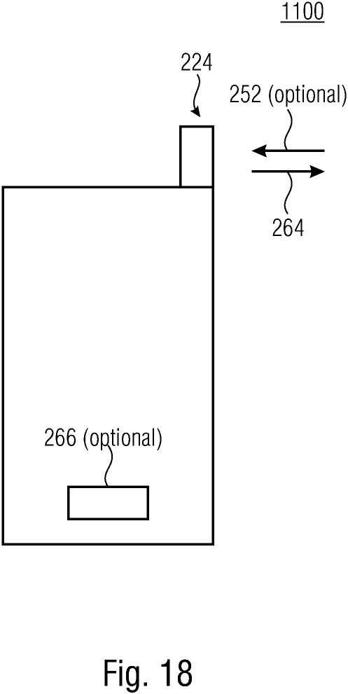

To enhance the operation of the network node and/or to support other network nodes to influence and/or provoke the network node, the network node may transmit a capability signal 264 as shown, for example, in FIG. 18 being a schematic block diagram of a network node 1100 according to an embodiment. Network node 1100 may, optionally, operate according to request 252. However, network node 1100 may also operate without request 252 or may ignore such a signal. By transmitting the capability signal 264, network node 1100 may inform other network nodes about its capability and/or sensitivity matrix or criterion. Alternatively or in addition, the capability signal 264 may indicate a capability of the device to influence its criterion. This may relate to a binary information, may indicate if it is able to select a criterion from a set of criteria, e.g., as UE-type #2, and/or if it may adopt one or more partial criteria, e.g., as UE-type #3, and/or more details such as specific elements and/or dimensions of the matrix. That is, the network node may transmit a signal, to the wireless communication network, comprising information indicating the criterion and/or an influenced criterion. The criterion may be indicated by one or more of indicating a specific type of beam correspondence capability; transmitting the signal so as to indicate the criterion being encoded into the network node by a preconfigured setting; and/or transmitting the signal so as to indicate a standard identifying the criterion, a standardised reference respectively. As a standardised reference, one may understand, for example, a known label or identifier to identify the criterion. For example, it may be contained information in the context of a specific release of a wireless communication standard providing default settings for a behavior. For example, the signal may be transmitted as to indicate a codebook entry, a table entry a matrix entry or other type of setting being agreed a-priori between different nodes by operating according to the standard such that the standard release may identify the criterion.

Embodiments have been described in view of allowing to influence a criterion to provide for a modified or adapted behaviour of the network node in view of responding to a stimulus beam pattern. However, forming such requests in the network may provide for additional help in the network, especially, when correlating the requests with a time, a location, an operating condition or the like of the requesting node and/or the requested node. When referring again to FIG. 18, network node 1100 may comprise an optional memory or data storage 266. Although being described in connection with network node 1100, the memory 266 and the described functionality may be implemented in any other network node according to an embodiment. Furthermore, the functionality described in connection with memory 266 may also be implemented without the capability of changing the criterion at the network node. The network node may record, to memory 266, information indicating the request. For example, the information may contain the requested criterion and/or the requested partial criterion and/or an amount by which a specific criterion or partial criterion is requested to be amended.

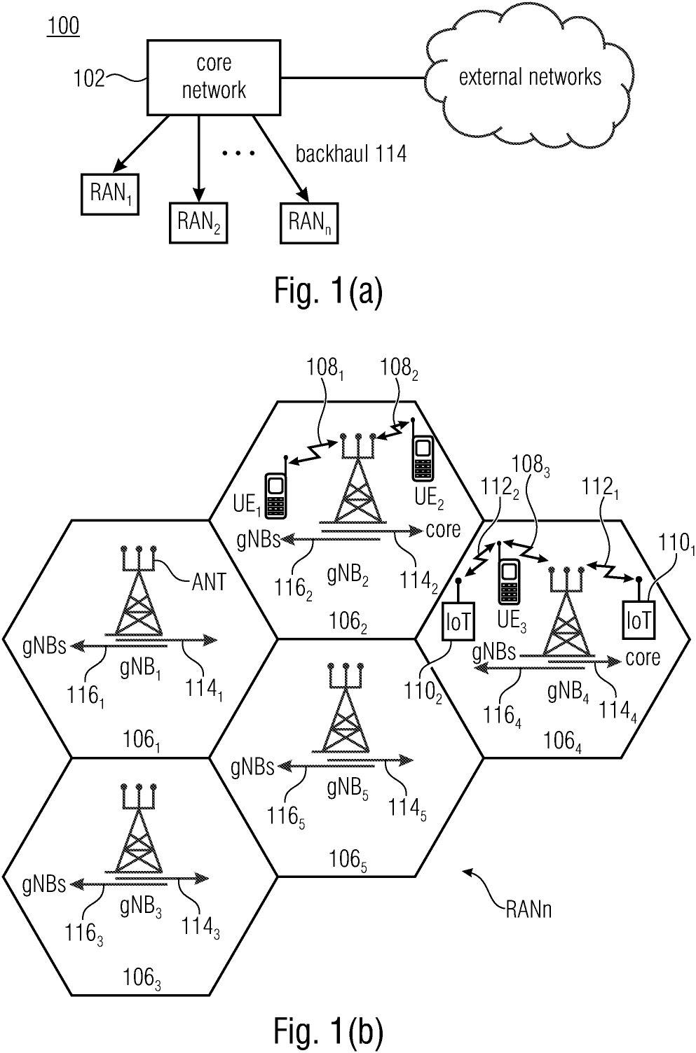

Alternatively or in addition, the network node may receive a signal from the wireless communication network, the signal containing information indicating a requested being associated with a specific area or node of the wireless communication network. Network node 1100 may store the information in memory 266 for a later use. For example, the request received, e.g., request 252 may be stored in memory 266. When entering or returning to the location of a node which has requested the influence of the criterion, e.g., one of the cells of the wireless communication network of FIG. 1, the network node may already implement the request although having not received signal 252 for this instance. This may also allow to have knowledge about the requests a network node transmits, prior to having received the request from this node. For example, such an information may be provided by a network operator, may be distributed in the network and/or may be distributed differently. That is, the network node may receive a signal from the wireless communication network, the signal containing information indicating a request to a different node. The request may be associated with a specific area or node of the wireless communication network. The network node may then store the information in a memory of the network node for a later use. The network node may store a content of the request and/or a recipient of the request and/or metadata such as time, repetition rate, validity or the like of the request.

The network node may, alternatively or in addition, receive a signal from the wireless communication network, the signal containing information indicating a request to a group of nodes to influence a criterion. For example, this may be a signal 252 being, however, not related to the receiving network node but to a group of nodes. The network node may store the request in the memory 266. Alternatively or in addition, the network node may implicitly determine that the request applies to itself and may operate according to the request. For example, implicitly may be understood as the network node being not explicitly part of the group but determines that the request relates to itself based on information or side-information contained in the request. Such (side-)information may be, for example, a specific capability such that UEs that are capable or not capable of performing specific actions are requested to do some sort of changes of the criterion such that the network node determines that it has to operate accordingly. Alternatively or in addition, this may relate to the data to be transmitted, e.g., quality of service requirements, an amount of data to be transmitted, a battery level being above or below a specific threshold or the like. Alternatively or in addition, the (side-)information may be available to the node beforehand, e.g. by configuration or availability of alternative criteria available in the node. For example, this may refer to knowledge available to the node a priori e.g. by having received a request that if others are requested to implement a specific action or to show a specific behaviour, the node is also requested to show the behaviour, i.e., to follow the behaviour of other nodes. In this case no explicitly command/side info is needed with the request to the group.

Alternatively or in addition, the network node may store a plurality of requests, e.g., so as to form measurement report and/or a log. Such a storing may be performed in at least one of a continuous manner, a timed manner, e.g., low-speed, high-speed or dynamic-speed, a sequenced manner, an ordered manner, a requested manner, a windowed manner, an instructed manner, an event-based manner, a trigger-based manner, a threshold-based manner, and/or a programmed or scripted manner. The network node may store information associated with the stored requests indicating whether the device has responded to the requests and, optionally, further information such as why it responded or why it did not respond.

Alternatively or in addition, the network node may store a plurality of requests, e.g., as a log or measurement report, together with a header, identifier, marker or stamp containing one or more of an absolute time, a relative time, a time relative to a slot in the wireless communication network, a frame or the start of service (uptime), a speed over ground, a location such as GPS/GNSS coordinates, an altitude, a cell ID, a beam ID, an antenna pattern, a cell sector, a service set identifier (SSID), an internet service provider (SIP), a pathloss model (PLM), a mobile network operator (MNO), a radio access technology (RAT) connection such as 5G, 4G, 3G, 2G, WI-FI, Bluetooth, LORAN and/or a service type such as VoIP, video on demand, augmented reality, virtual reality, or the like.

According to an embodiment, the network node may transmit a report, to a node of the wireless communication network, containing an information about requests the network node has received and/or stored. That is, the log and/or measurement report the node has generated and stored in memory 266 may be reported to the network. That is, the network node may read, from the memory, the information indicating the request and implement the request prior to receiving the request. The network node may transmit the report based on a received request to transmit the report and/or in a scheduled or spontaneous manner. Together with the report, it may transmit the additional information indicating whether it has responded and/or why it has or has not responded.

The network node may transmit a signal to the wireless communication network, the signal containing information indicating a request being associated with a specific area or node of the wireless communication network. Alternatively or in addition, the information may indicate the received request, the requested being directed to the network node or a different network node. That is, the network node may also log requests that are not directed to itself, e.g., neither explicitly nor implicitly. This may allow to report and distribute information in the network about requests that are transmitted by a specific node, even if the recording node is not subject of the request.

Embodiments may thus allow to distribute different requests throughout the network. A network node may, for example, receive different requests, e.g., from a same or different requesting nodes, the different requests leading to requests for differently changing the criterion. The network node may decide which of the, possibly contradicting requests, to follow. Alternatively or in addition, the network node may decide about request to be dismissed. Such a decision, following a specific request and/or dismissing a request may be performed, for example, by a ranking or priority. For example, a base station which provides more service when compared to another base station may comprise a higher rank when compared to a different base station. Alternatively or in addition, the UE expecting a handover may already follow the request of the base station to which it expects to be handed over whilst neglecting the request of the still serving base station or the like.

According to an embodiment, the network node may evaluate the request for an authorization information. Such an authorization information may indicate a hierarchy, priority and/or an authority or a permission to send the request. The network node may influence the criterion based on the request if the authorization information corresponds to a predetermined authorization information. Further, the network node may not influence the criterion based on the request if the authorization information does not correspond to the predetermined authorization information. The authorization information may indicate, for example, an authority level of an entity generating the request, a priority level of the request and/or a hierarchy level of the entity generating the request. This may allow to hamper an abuse of the mechanism. Furthermore, such a mechanism may allow to select between different criterions if contradicting requests are received.

The network node may receive the request as part of a message having a protected content, e.g., based on encryption or the like. That is, the request might be needed to be decrypted or the like. Same or similar mechanisms may be applied by the network node when transmitted a log or a measurement report. Protected content may relate to describe encrypted, restricted and authenticated content.

As described using memory 266 for storing and/or recording information may be implemented even if the network node is unable to change its criterion. Embodiments, thus, relate to a network node configured for wirelessly transceiving signals for operating in a wireless communications network. The network node is to form a response beam pattern responsive to a recognized stimulus beam pattern of a stimulating node based on a criterion. The network node may have access to memory 266 having stored thereon information indicating different criterions associated with communication scenarios including different locations, areas or nodes of the wireless communication network. The network node may determine a change from a first communication scenario to a second communication scenario, e.g., when entering a different cell in the wireless communication network and/or communicating with a different node, and may read, from the memory 266, the information relating to the second communication scenario. The network node may influence the criterion based on the information related to the second communication scenario.

Wireless communication networks in accordance with embodiments comprise at least one network node that requests for an influence or change of a criterion or partial criterion and at least one network node that implements such a request, e.g., as a responding network node. Such a wireless communication network may comprise, optionally, a network controller, e.g., a central entity, to instruct one or more network nodes to cause a responding network node to influence or change its criterion and/or to instruct one or more network nodes to provoke a responding network node to generate a favourite beam pattern or to instruct a further node accordingly. This may allow to allow for mechanisms such as forwarding in the network.

Embodiments allow for
Enhanced options of aligning mechanisms of decision making for convergence and/or tracking of configured/defined stimulus-response pairs
Influence the output behaviour / a response to a stimulus by novel signalling mechanism
Influence the evaluation/consideration of available stimuli/input signals
Signalling and control mechanism of algorithmic behaviour / tendencies without directly interfering with the actual algorithmic approach, allowing proprietary implementations
Improved link and system performance by adapting the input/ stimulus to output/response relation by controlling/setting side constraints in form of a sensitivity matrix
Improved bi-directional beam refinement sharing “rules” of how to respond to stimuli, allowing to orchestrate link alignment/management single sided or by mutual/crosswise influence/guidance e.g. UE movement tracking by following the main direction of arrival (DoA) relative to the base station in order to expose the UE to a good level of stimulus signal by pointing into the “right” direction.

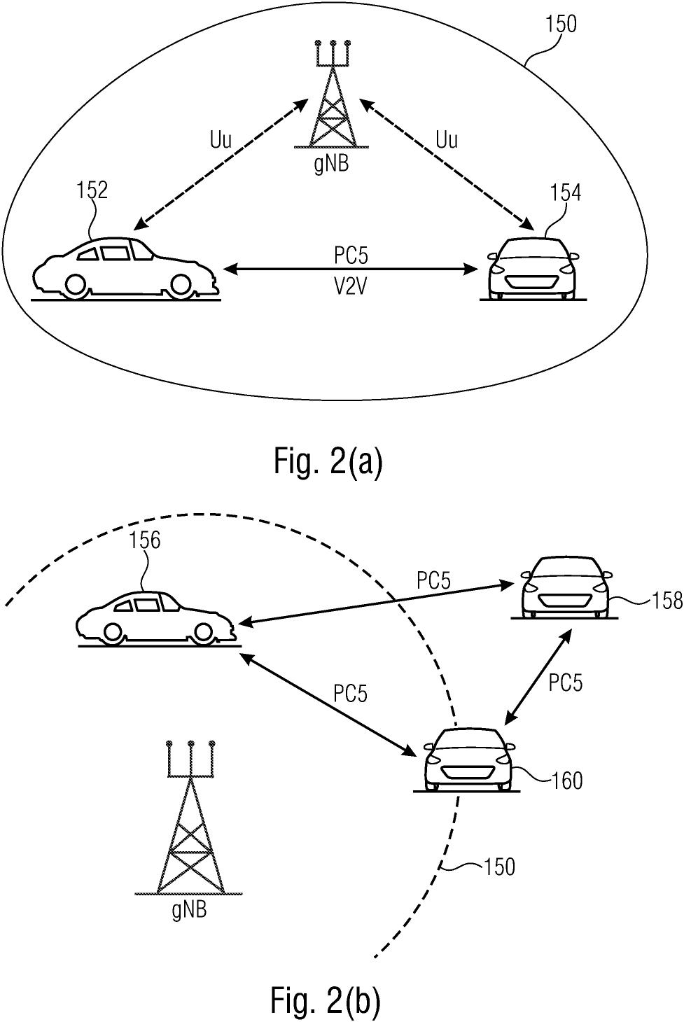

In a wireless communication system or network, like the one described above with reference to FIG. 1 or with reference to FIG. 2, payload, like payload data, to be transmitted among respective entities of the wireless communication network may be carried in what is known as one or more transport blocks, TBs. For example, when considering the 3GPP release 16, NR V2X uses resource pools for the transmission and reception of data or data packets, and a resource pool may include a physical sidelink control channel, PSCCH, and a physical sidelink shared channel, PSSCH, among other physical layer channels. When a UE transmits a data packet in a transport block, TB, the transmission comprises one or more time slots formed by a continuous set of symbols across time and a sub channel formed by a continuous set of resource blocks, RBs, across frequency. The symbols and the RBs include the PSCCH and the PSSCH. The PSCCH may occupy initial symbols in the time slot followed by the PSSCH symbols.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fibre optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system. The computer programs, also referred to as computer control logic, are stored in main memory and/or secondary memory. Computer programs may also be received via the communications interface. The computer program, when executed, enables a computer system to implement the present invention. In particular, the computer program, when executed, enables processor to implement the processes of the present invention, such as any of the methods described herein. Accordingly, such a computer program may represent a controller of the computer system. Where the disclosure is implemented using software, the software may be stored in a computer program product and loaded into computer system using a removable storage drive, an interface, like communications interface.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

ABBREVIATIONS

| | | |
|---|---|---|
| Abbreviation | Definition | Further description |
| 2G | second generation | |
| 3G | third generation | |
| 3GPP | third generation partnership project | |
| 4G | fourth generation | |
| 5G | fifth generation | |
| 5GC | 5G core network | |
| ACLR | adjacent channel leakage ratio | |
| AP | access point | |
| ARQ | automatic repeat request | |
| BER | bit-error rate | |
| BLER | block-error rate | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal strength | |
| CP1 | control plane 1 | |
| CP2 | control plane 2 | |
| CSI-RS | channel state information reference signal | |
| CU | central unit | |
| D2D | device-to-device | |
| DAPS | dual active protocol stack | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DU | distributed unit | |
| ECGI | E-UTRAN cell global identifier | |
| E-CID | enhanced cell ID | |
| eNB | evolved node b | |
| EN-DC | E-UTRAN-New Radio dual connectivity | |
| EUTRA | Enhanced UTRA | |
| E-UTRAN | Enhanced UTRA network | |
| gNB | next generation node-b | |
| GNSS | global navigation satellite system | |
| GPS | global positioning system | |
| HARQ | hybrid ARQ | |
| IAB | integrated access and backhaul | |
| ID | identity / identification | |
| IIOT | industrial Internet of things | |
| KPI | key-performance indicator | |
| LTE | Long-term evolution | |
| MCG | master cell group | |
| MCS | modulation coding scheme | |
| MDT | minimization of drive tests | |
| MIMO | multiple-input / multiple-output | |
| MLR | measure, log and report | |
| MLRD | MLR device | |
| MNO | mobile network operator | |
| MR-DC | multi-RAT dual connectivity | |
| NCGI | new radio cell global identifier | |
| NG | next generation | |
| ng-eNB | next generation eNB | node providing E-UTRA user |
| NG-RAN | either a gNB or an ng-eNB | |
| NR | new radio | |
| NR-U | NR unlicensed | NR operating in unlicensed |
| OAM | operation and maintenance | |
| OEM | OEM original equipment manufacturer | |
| OTT | OTT over-the-top | |
| PCI | physical cell identifier | Also known as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information management | |
| RIM-RS | RIM reference signal | |
| RLC | radio link control | |
| RLF | radio link failure | |
| RLM | radio link monitoring | |
| RP | reception point | |
| R-PLMN | registered public land mobile network | |
| RRC | radio resource control | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| SA | standalone | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal / physical broadcast channel | |
| TAC | tracking area code | |
| TB | transmission block | |
| TDD | time division duplex | |
| TSG | technical specification group | |
| UE | user equipment | |
| UL | uplink | |
| URLLC | ultra-reliable low latency communication | |
| UTRAN | universal trunked radio access network | |
| V2X | vehicle-to-everything | |
| VoIP | voice over Internet protocol | |
| WI | work item | |
| WLAN | wireless local area network | |

1. A network node configured for wirelessly transceiving signals for operating in a wireless communications network;
wherein the network node is to form a response beam pattern responsive to a recognized stimulus of a stimulating node based on a criterion;
wherein the network node is to receive a signal comprising a request to influence the criterion;
wherein the network node is to influence the criterion based on the request.

2. The network node of claim 1,
wherein the stimulus is representable as at least an element of at least a stimulus vector;
wherein the criterion is representable as a sensitivity matrix indicating a behaviour of the network node;
wherein a combination of the stimulus vector and the sensitivity matrix provide for a reaction vector indicating the response beam pattern; and
wherein changing the criterion leads to a different response beam pattern based on a same stimulus vector;
wherein the request is related to a request to influence or change at least one element of the stimulus matrix.

3. The network node of claim 1, wherein the network node is to form the response beam pattern as a reproducible combination of input factors comprising at least one parameter of the stimulus.

4. The network node of claim 3, wherein the combination is a linear combination.

5. The network node of claim 4, wherein the combination is a non-linear combination.

6. The network node of claim 3, wherein the network node is to implement the combination of input factors by implementing a sensitivity matrix and to use the input factors at least as an input vector for the sensitivity matrix so as to acquire a result vector indicating the response beam pattern or providing for a basis of decision making for a selection of a response beam pattern, wherein the criterion relates to at least one matrix element of the sensitivity matrix.

7. The network node of claim 3, wherein the network node is to implement the combination of input factors by implementing a lookup table or a weighting of the input factors in the combination, wherein the criterion relates to at least one weight of the weighting.

8. The network node of claim 1, wherein the network node is to implement the criterion as a sensitivity matrix that combines at least the stimulus as a stimulus vector to acquire an output vector indicating the response beam pattern or forming a basis for a decision of the response beam pattern.

9. The network node of claim 8, comprising a plurality of pre-defined sensitivity matrices, wherein the network node is to select one of the plurality or a specific combination of the plurality of sensitivity matrices based on the request; or
wherein the network node comprises at least one sensitivity matrix and is to influence or change at least one element of the sensitivity matrix responsive to the request.

10. The network node of claim 1, wherein the network node is to determine the stimulus as being mapped to at least one carrier of the wireless communication network; and to form the response beam pattern on at least one same or different carrier; and/or
wherein the network node is to determine the stimulus as being mapped to a first channel set of the wireless communication network; and to form the response beam pattern on a different second channel set.

11. The network node of claim 1, wherein the network node is to determine a plurality of signals comprising a plurality of potential stimuli and to select, from the plurality of potential stimuli a selected stimulus as the stimulus to be responded to.

12. The network node of claim 1, wherein the criterion is influenced so as to adapt beamforming of the network node for a wireless communication with the stimulating network node.

13. The network node of claim 1, wherein the network node is to implement the criterion as a plurality of partial criteria so as to provide for a weighted mapping of at least one input comprising the stimulus to at least one output comprising the response beam pattern, wherein the network node is to adapt, based on the request, at least one partial criteria.

14. The network node of claim 1, wherein the network node is to receive a signal from the wireless communication network, the signal comprising information indicating a request to a different node, the request being associated with a specific area or node of the wireless communication network and to store the information in a memory of the network node for a later use.

15. A network node configured for wirelessly transceiving signals for operating in a wireless communications network;
wherein the network node is to transmit a signal indicating a request, to a responding network node, to influence a criterion according to which the responding network node selects a response beam pattern as a response to a stimulus.

16. The network node of claim 15, wherein the network node has access to information indicating a structure of partial criterions of the responding node and for generating the stimulus so as to result in a favoured beam pattern selected by the network node based on the structure of partial criterions.

17. The network node of claim 15, wherein the network node has access to information indicating a structure of partial criterions of the responding node and to generate the request so as to request a influence of at least one partial criterion.

18. The network node of claim 17, wherein a partial criterion implements a weighting within a selection procedure of the responding node to select the response beam pattern from a plurality of possible beam patterns, wherein the network node is to generate the request to modify the weighting.

19. A method to operate a network node to wirelessly transceive signals for operating in a wireless communications network, the network node to form a response beam pattern responsive to a recognized stimulus of a stimulating node based on a criterion, the method comprising:
receiving a signal indicating a request to influence the criterion; and
changing the criterion based on the request.

20. A method to operate a network node to wirelessly transceiving signals for operating in a wireless communications network, the method comprising:
transmitting a signal indicating a request, to a responding network node, to influence a criterion according to which the responding network node selects a response beam pattern as a response to a stimulus.
